(19) United States
(12) Patent Application Publication
(10) Pub. No.: US 2019/0085740 A1
(43) Pub. Date: Mar. 21, 2019

(54) INTERNAL COMBUSTION ENGINE

(71) Applicant: Suzuki Motor Corporation, Hamamatsu-shi (JP)

(72) Inventor: Hisashi OZEKI, Hamamatsu-shi (JP)

(73) Assignee: SUZUKI MOTOR CORPORATION

(21) Appl. No.: 16/125,186

(22) Filed: Sep. 7, 2018

(30) Foreign Application Priority Data
Sep. 15, 2017 (JP) 2017177992

(51) Int. Cl. F01M 1/08; F01M 1/06; F01P 3/08; F01P 3/10; F02F 3/22; F02F 3/00

(52) U.S. Cl. CPC F01M 1/08; F01M 1/06; F01P 3/08; F01M 2001/083; F02F 3/22; F02F 3/0069; F01M 2001/086; F01P 3/10

(57) ABSTRACT

To provide an internal combustion engine that can inject lubricating oil to both of the first region in the skirt of the piston and the second region outside the skirt with fewer nozzles. An internal combustion engine including: a piston configured to reciprocate in a cylinder bore; and an oil injector configured to inject lubricating oil to the piston. The piston includes pin bosses, skirts, side walls, and a piston inner region that is surrounded by respective inner surfaces of the pin bosses, skirts, and side walls. The oil injector is configured to inject the lubricating oil to the pair of pin bosses when the piston is at one of a top dead center and a bottom dead center, and inject the lubricating oil to the piston inner region when the piston is at another of the top dead center and the bottom dead center.

### CROSS-REFERENCE TO RELATED APPLICATIONS

This application claims the benefit of priority of Japanese Patent Application No. 2017-177992, filed on Sep. 15, 2017, the entire contents of which are incorporated herein by reference.

### BACKGROUND OF THE INVENTION

### Field of the Invention

The present invention relates to an internal combustion engine.

### Description of the Related Art

A conventional internal combustion engine includes a nozzle for injecting lubricating oil to a first region inside a skirt of a piston and another nozzle for injecting the lubricating oil to a second region outside the skirt (e.g., Japanese Unexamined Patent Application Publication No. 2008-163936).

That is, the conventional internal combustion engine includes separate nozzles for cooling the corresponding of the first region and the second region. For this reason, in the case of cooling three portions including the first region and a pair of pin bosses provided in the second region for supporting a piston pin, the conventional internal combustion engine requires at least three nozzles.

### SUMMARY OF THE INVENTION

To solve the problem described above, it is an object of the present invention to provide an internal combustion engine that can inject lubricating oil to both of the first region inside the skirt of the piston and the second region outside the skirt with fewer nozzles.

To achieve the above object, an internal combustion engine including: a cylinder having a cylinder bore; a piston configured to reciprocate in the cylinder bore; and an oil injector configured to inject lubricating oil to the piston. The piston includes a pair of pin bosses, a pair of skirts, a pair of side walls that connect the pair of pin bosses to the pair of skirts, and a piston inner region that is surrounded by respective inner surfaces of the pair of pin bosses, respective inner surfaces of the pair of skirts, and respective inner surfaces of the pair of side walls. The oil injector is configured to inject the lubricating oil to the pair of pin bosses when the piston is at one of a top dead center and a bottom dead center, and inject the lubricating oil to the piston inner region when the piston is at another of the top dead center and the bottom dead center.

According to the present invention, it is possible to provide an internal combustion engine that can inject lubricating oil to both of the first region inside the skirt of the piston and the second region outside the skirt with fewer nozzles.

### BRIEF DESCRIPTION OF THE DRAWINGS

In the accompanying drawings:

FIG. 1 is a left side view illustrating a motorcycle to which an internal combustion engine according to one embodiment of the present invention is applied;

FIG. 2 is a front view illustrating the internal combustion engine according to the embodiment of the present invention;

FIG. 3 is a left side view illustrating the internal combustion engine according to the embodiment of the present invention;

FIG. 4 is a schematic system diagram of lubricating structure for the internal combustion engine according to the embodiment of the present invention;

FIG. 5 is a schematic perspective view of the lubrication structure for the internal combustion engine according to the embodiment of the present invention;

FIG. 6 is a cross-sectional view of the internal combustion engine according to the embodiment of the present invention, taken along the line VI-VI of FIG. 2;

FIG. 7 is a cross-sectional view of the internal combustion engine according to the embodiment of the present invention, taken along the line VII-VII of FIG. 2;

FIG. 8 is a cross-sectional view of the internal combustion engine according to the embodiment of the present invention, taken along the line VIII-VIII of FIG. 3;

FIG. 9 is a schematic view illustrating relationship between a piston and a piston jet of the internal combustion engine according to the embodiment of the present invention;

FIG. 10 is a schematic view illustrating relationship between the piston and another aspect of the piston jet of the internal combustion engine according to the embodiment of the present invention;

FIG. 11 is a partially enlarged view of the right side surface of the right case half of the internal combustion engine according to the embodiment of the present invention;

FIG. 12 is a perspective view of a part of the clutch chamber of the internal combustion engine according to the embodiment of the present invention;

FIG. 13 is a cross-sectional view of a blowby-gas inlet port of the internal combustion engine according to the embodiment of the present invention, taken along the line XIII-XIII of FIG. 11;

FIG. 14 is an enlarged view of a part of FIG. 6 for illustrating the breather chamber of the internal combustion engine according to the embodiment of the present invention; and

FIG. 15 is an enlarged view of a part of FIG. 7 for illustrating the breather chamber of the internal combustion engine according to the embodiment of the present invention.

### DETAILED DESCRIPTION

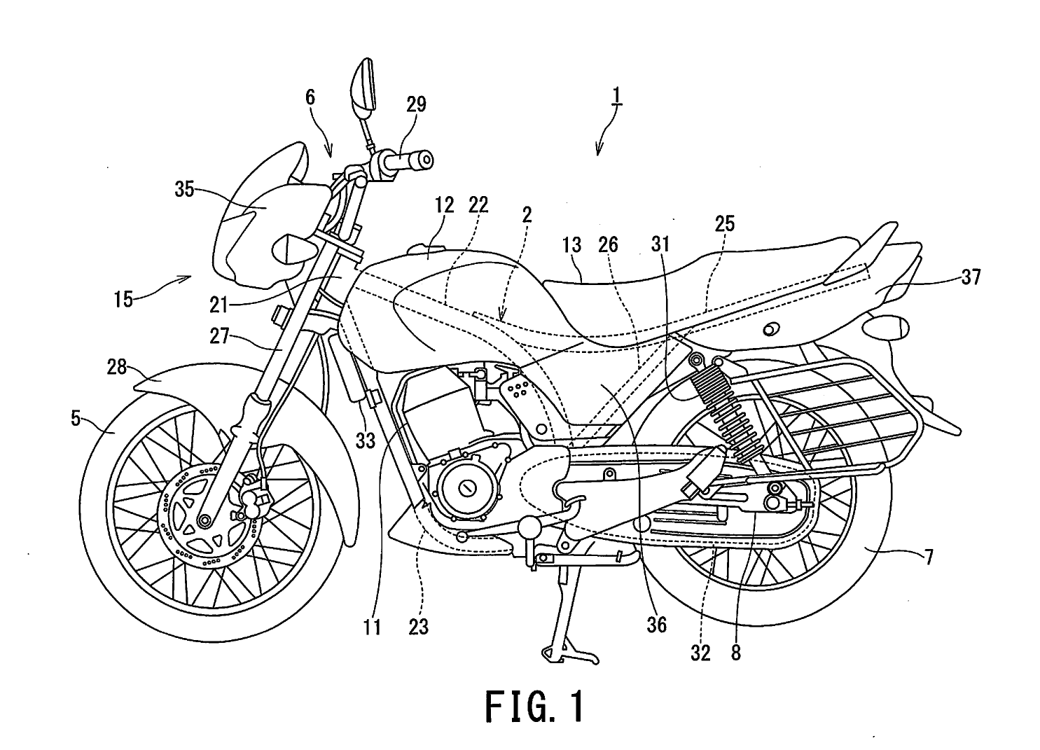

Hereinafter, an embodiment of an internal combustion engine according to the present invention will be described by referring to FIG. 1 to FIG. 15. The same reference signs are given for identical or equivalent components in each figure.

FIG. 1 is a left side view illustrating a motorcycle to which the internal combustion engine according to the embodiment of the present invention is applied.

In the present embodiment, directional terms such as front, rear, upper, upward, lower, downward, left, and right are used with reference to a rider who rides on the motorcycle 1.

As shown in FIG. 1, the motorcycle 1 according to the embodiment of the present invention includes a body frame 2 that extends in the front-rear direction of the motorcycle 1, a front wheel 5 disposed in front of the body frame 2, a steering mechanism 6 that is disposed at the front end portion of the body frame 2 and rotatably supports the front wheel 5, a rear wheel 7 disposed behind the body frame 2, a swing arm 8 that is disposed at the rear of the body frame 2 and rotatably supports the rear wheel 7, and the internal combustion engine 11 (hereinafter simply referred to as the engine 11) mounted on the body frame 2. The motorcycle 1 further includes a fuel tank 12 disposed above the front half of the body frame 2 for storing fuel supplied to the engine 11, a seat 13 disposed above the rear half of the body frame 2 for seating a rider, and a vehicle-body cover 15 that covers a part of the body frame 2.

The body frame 2 is a so-called cradle type. The body frame 2 includes plural steel hollow tubes that are combined together. In other words, the body frame 2 includes a head pipe 21, a main tube 22, a down tube 23, a pair of right and left seat rails 25, and a pair of right and left seat pillars 26.

The head pipe 21 is disposed at the upper front end of the body frame 2. The head pipe 21 supports the steering mechanism 6 such that the steering mechanism 6 can be steered in the right-and-left direction (i.e., lateral direction) of the motorcycle 1.

The main tube 22 extends obliquely rearward and downward from a front end portion connected with an upper portion of a rear surface of the head pipe 21, and is curved in the middle so as to hang downward.

The down tube 23 extends rearward while tilting further downward below the main tube 22 from a front end portion connected with a lower part of the rear surface of the head pipe 21, and is curved in the middle so as to extend rearward.

The pair of right and left seat rails 25 branch off from a front end portion connected with a curved portion of the main tube 22, and extend obliquely rearward and upward gradually and gently.

The pair of right and left seat pillars 26 branch off from the front end portion connected with the main tube 22 so as to extend obliquely rearward and upward, and are integrated at the intermediate portion of the length of each seat rail 25 so as to support the seat rails 25.

The steering mechanism 6 includes a pair of right and left front forks 27 that have a non-illustrated suspension mechanism and rotatably support the front wheel 5, a front fender 28 covering above the front wheel 5, and a handle 29 fixed to the top of the front forks 27.

The front wheel 5 is interposed between the right and left front forks 27, and rotates around an axle that is installed at a lower end portion of the right and left front forks 27.

The swing arm 8 is supported with a non-illustrated pivot shaft provided on the body frame 2, and is swingable in the up-and-down direction (i.e., vertical direction). An axle for rotatably supporting the rear wheel 7 is provided at a rear end portion of the swing arm 8. A rear cushion unit 31 is installed between the body frame 2 and the swing arm 8. The rear cushion unit 31 buffers the force transmitted from the rear wheel 7 to the body frame 2.

A drive chain 32 transmits the output of the engine 11 to the rear wheel 7 so as to rotate the rear wheel 7.

The engine 11 is disposed between the main tube 22 and the down tube 23, and is fixed to the main tube 22 and the down tube 23.

Obliquely in front of and above the engine 11, there is provided an oil cooler 33 for cooling the lubricating oil that is used for lubrication and cooling of the respective components of the engine 11. The oil cooler 33 is preferably disposed so as to avoid the position where the oil cooler 33 faces the front fender 28 and the front wheel 5 in order for the oil cooler 33 to be easily exposed to traveling wind of the motorcycle 1.

The fuel tank 12 is exclusively supported by the main tube 22. The fuel tank 12 expands from just behind the head pipe 21 to the vicinity of the front end portions of the respective seat rails 25.

The seat 13 is provided behind the fuel tank 12. The seat 13 straddles the right and left seat rails 25 and reaches the rear end portions of the respective seat rails 25. A rider of the motorcycle 1 sits on the seat 13 and boards the motorcycle 1.

The vehicle-body cover 15 includes a front cover 35, a pair of right and left side covers 36, and a rear cover 37. Each of the front cover 35, the side covers 36, and the rear cover 37 is made of a synthetic resin.

The front cover 35 is provided in front of the head pipe 21. The front cover 35 is fixed to the steering mechanism 6.

The right and left side covers 36 are connected with the lower rear portion of the fuel tank 12 and extend in an inverted triangle shape across the main tube 22, the seat rails 25, and the seat pillars 26 so as to sandwich them from both right and left sides.

The rear cover 37 is connected with the respective lower end portions of the right and left side surfaces of a rear half portion of the seat 13 so as to spread rearward, and extends to a rear side of the seat 13 so as to be integrated at its rear end.

Next, the engine 11 according to the embodiment of the present invention will be described in detail.

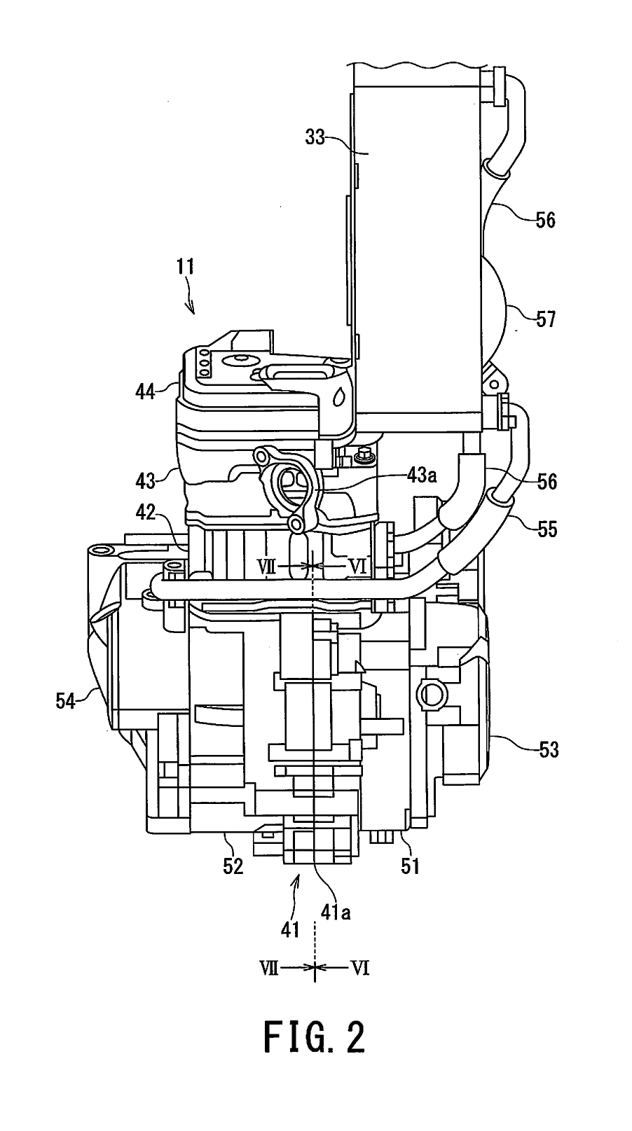

FIG. 2 is a front view illustrating the internal combustion engine according to the embodiment of the present invention.

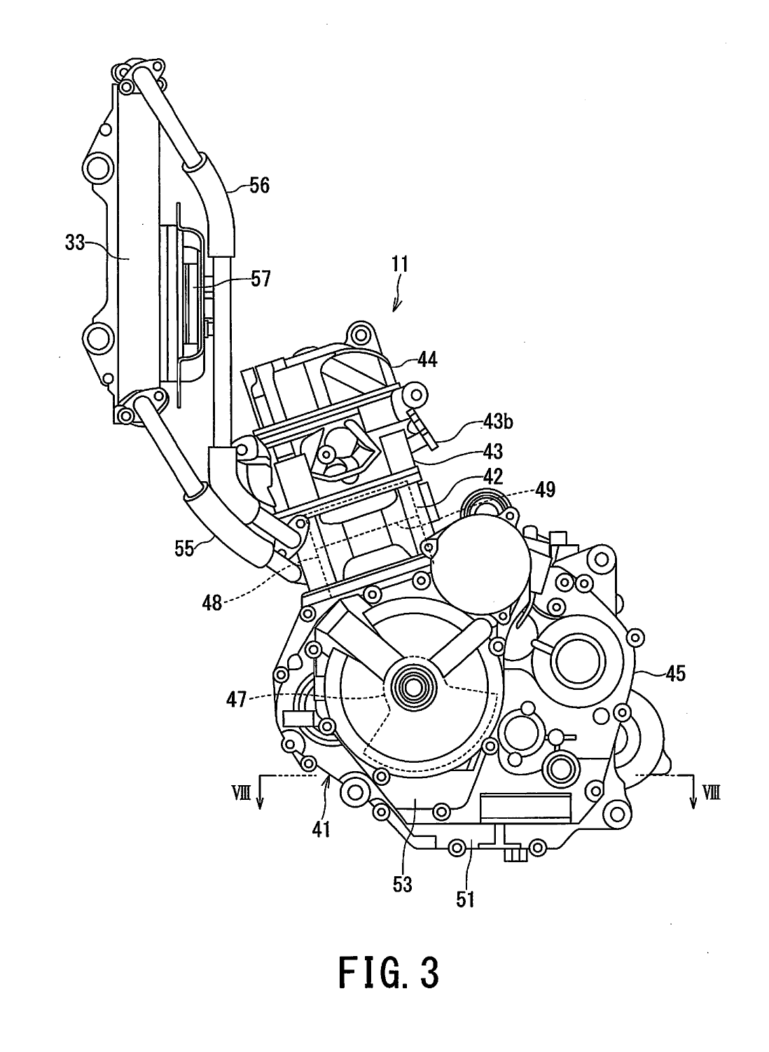

FIG. 3 is a left side view illustrating the internal combustion engine according to the embodiment of the present invention.

As shown in FIG. 2 and FIG. 3, the engine 11 according to the embodiment of the present invention is, e.g., an internal combustion engine with a small displacement of 50 cc class or 250 cc class. The engine 11 is a four-cycle single cylinder internal combustion engine. The engine 11 includes a crankcase 41, a cylinder 42 combined with the crankcase 41, a cylinder head 43 combined with the cylinder 42, and a head cover 44 combined with the cylinder head 43.

The crankcase 41 is made of an aluminum alloy. The crankcase 41 is disposed at the lower half of the engine 11. The crankcase 41 includes a transmission case 45 that is integrated with the crankcase 41.

The crankcase 41 includes a left case half 51 and a right case half 52, and can be divided into left and right. The left case half 51 and the right case half 52 are combined with each other at a mating surface 41a that is substantially orthogonal to a rotation center line of a crankshaft 47. In other words, the right and left case halves 52 and 51 are integrated at the mating surface 41a. The crankcase 41 includes a pair of right and left case halves 51 and 52 combined with each other at the mating surface 41a that is substantially perpendicular to the rotation center line of the crankshaft 47.

In addition, the crankcase 41 includes a left case cover 53 provided on the left side of the left case half 51 and a right case cover 54 provided on a right side of the right case half 52. The left case cover 53 is a magneto cover, and the right case cover 54 is a clutch cover.

The cylinder 42 is joined to a front part of the upper surface of the crankcase 41 in a forward inclined posture in which the center line of a cylinder bore 48, i.e., the movement direction of the piston 49 is inclined slightly forward.

The cylinder head 43 is coupled to a top of the cylinder 42 so as to block the cylinder 42. An outlet flange 43a of a non-illustrated exhaust port is provided at a front of the cylinder head 43. An inlet flange 43b of a non-illustrated intake port is provided on a rear surface of the cylinder head 43.

The head cover 44 is coupled to a top of the cylinder head 43 so as to block the cylinder head 43.

The oil cooler 33 is connected to the engine 11 via oil hoses 55 and 56.

The oil cooler 33 includes a fan 57 for generating cooling air. The oil cooler 33 cools the lubricating oil flowing in from the oil hose 55 by using the wind of the fan 57 and the running wind of the motorcycle 1, and then returns the cooled lubricating oil from the oil hose 56 to the engine 11.

The oil hoses 55 and 56 circulate the lubricating oil between the engine 11 and the oil cooler 33.

The oil hose 55 disposed below sends the oil from the engine 11 to the oil cooler 33. The oil hose 55 extends from the corner between a front wall and a right side wall of the cylinder 42, and further extends to the oil cooler 33 bypassing a front of the cylinder 42. The oil hose 55 is connected to a bottom of the oil cooler 33.

The oil hose (i.e., first return oil passage) 56 disposed above returns the lubricating oil from the oil cooler 33 to the engine 11. The oil hose 56 extends from a corner between the front wall and a left side wall of the cylinder 42 to the oil cooler 33. The oil hose 56 is connected to a top of the oil cooler 33.

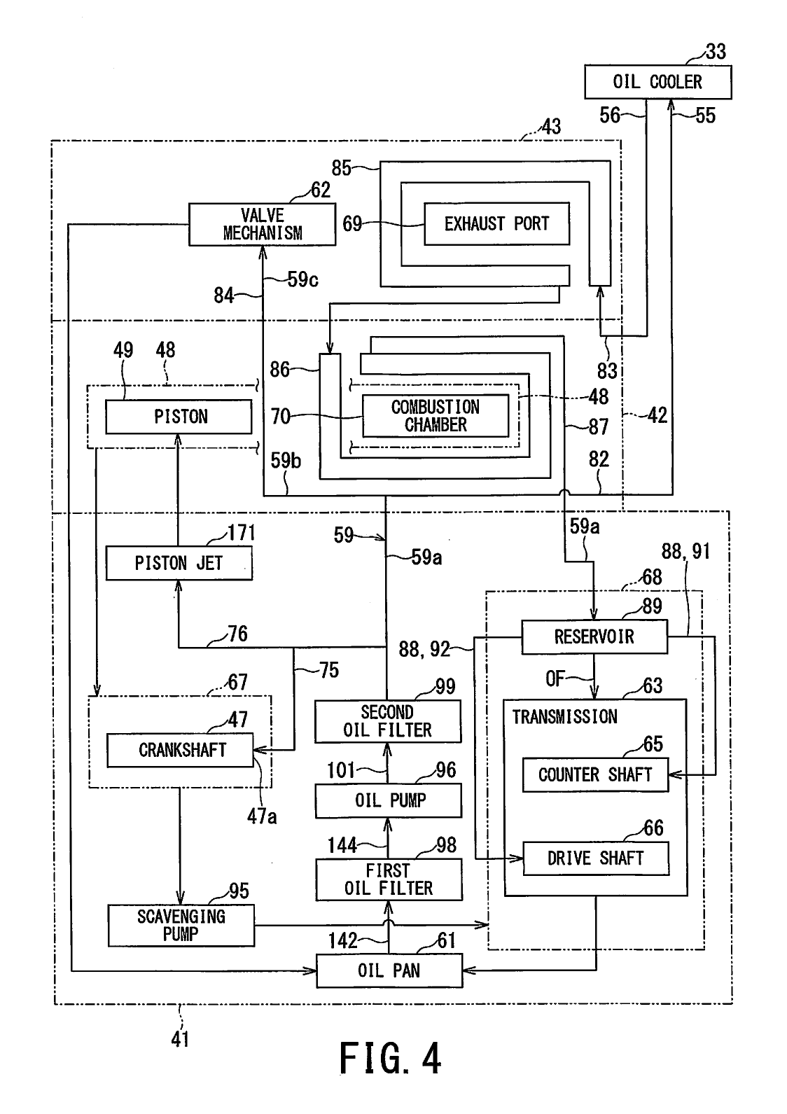

FIG. 4 is a schematic system diagram of lubricating structure for the internal combustion engine according to the embodiment of the present invention.

As shown in FIG. 4, the engine 11 according to the embodiment of the present invention includes an oil passage 59 that is provided in the crankcase 41, the cylinder 42, and the cylinder head 43 and serves as an internal-combustion-engine-side oil passage for circulating the lubricating oil. In other words, the engine 11 is an oil cooling engine.

The engine 11 further includes an oil pan 61 that is provided at a bottom of the crankcase 41 as an oil storage part for storing the lubricating oil.

The engine 11 supplies the lubricating oil stored in the oil pan 61 to respective components to be lubricated such as the crankshaft 47, the piston 49, a valve mechanism 62, a counter shaft 65 of a transmission 63, and a drive shaft 66 of the transmission 63 so as to lubricate and cool those components.

The crankcase 41 includes a crank chamber 67 that accommodates the crankshaft 47 and a transmission chamber 68 that accommodates the transmission 63. The transmission chamber 68 is partitioned by a transmission case 45. In other words, the crankcase 41 partitions the crank chamber 67, and the transmission case 45 partitions the transmission chamber 68. The crank chamber 67 and the transmission chamber 68 are arranged in the front-rear direction of the engine 11. The crank chamber 67 is disposed in the front half portion of the crankcase 41, and the transmission chamber 68 is disposed in the rear half portion of the crankcase 41.

The crankshaft 46 is rotatably supported in the crank chamber 67. The crankshaft 47 is disposed such that the rotation center line of the crankshaft 47 matches the width direction of the crankcase 41, i.e., the width direction of the engine 11. The piston 49 is housed (i.e., accommodated) in the cylinder bore 48 of the cylinder 42 so as to be able to reciprocate. The piston 49 reciprocates in the cylinder 42. The valve mechanism 62 is housed in a non-illustrated valve chamber of the cylinder head 43. The counter shaft 65 and the drive shaft 66 are housed in the transmission chamber 68.

The oil cooler 33 is disposed above the highest point of the oil passage 59. The oil cooler 33 cools the non-illustrated lubricating oil that flows through the oil passage 59. The lubricating structure of the internal combustion engine includes the oil cooler 33 and the oil passage 59 of the engine 11.

An oil passage 59a of the crankcase 41 includes a forward passage for drawing the lubricating oil from the oil pan 61 and feeding it to an oil passage 59b of the cylinder 42, and a backward passage for returning the lubricating oil from the oil passage 59b of the cylinder 42 to the oil pan 61.

The forward passage of the oil passage 59a includes a crankshaft lubricating-oil passage 75 that leads the lubricating oil from the oil pan 61 to the shaft end 47a of the crankshaft 47 and a piston-cooling oil passage 76 that injects the lubricating sent from the oil pan 61 to the piston 49.

The lubricating oil supplied to the shaft end 47a of the crankshaft 47 lubricates a non-illustrated bearing for rotatably supporting the crankshaft 47 and a non-illustrated connecting rod for connecting the crankshaft 47 with the piston 49, and then drips into the crank chamber 67.

The lubricating oil injected to the piston 49 drips into the crank chamber 67.

The oil passage 59b of the cylinder 42 includes a first oil passage 81 directly connected to the cylinder head 43, a second oil passage 82 connected to the oil cooler 33 via the oil hose 55, and a third oil passage 83 that is connected to the oil cooler 33 via the oil hose 56 and is also connected to the cylinder head 43.

The oil hose 56 is the first return oil passage for returning the lubricating oil cooled with the oil cooler 33 to the oil passage 59b in the cylinder 42.

The oil passage 59c of the cylinder head 43 includes a fourth oil passage 84 that leads the lubricating oil flowing in from the first oil passage 81 of the cylinder 42 to the valve mechanism 62 and a fifth oil passage 75 that cools periphery of an exhaust port 69 by using the lubricating oil flowing in from the third oil passage 83 of the cylinder 42.

The oil passage 59b of the cylinder 42 includes a sixth oil passage 86 that circulates the lubricating oil flowing in from the fifth oil passage 85 of the cylinder head 43 around a combustion chamber 70 and a seventh oil passage 87 that returns the lubricating oil from the sixth oil passage 86 into the crankcase 41.

The seventh oil passage 87 is the second return oil passage for returning the lubricating oil that has returned from the oil cooler 33 to the crankcase 41 after cooling the cylinder 42 and the cylinder head 43.

The backward passage of the oil passage 59a of the crankcase 41 includes a reservoir 89 configured to store the lubricating oil flowing out of the seventh oil passage 87 of the cylinder 42 and an eighth oil passage 88 connected to the reservoir 89.

The reservoir 89 is open to the transmission chamber 68. Thus, the lubricating oil of the reservoir 89 fills the reservoir 89 and overflows from the reservoir 89 to the transmission chamber 68 as shown by the solid-line arrow of in FIG. 4. The lubricating oil overflowing the transmission chamber 68 from the reservoir 89 lubricates the transmission 63, and then drips into the oil pan 61.

The eighth oil passage 88 is a transmission lubricating-oil passage that leads the lubricating oil from the reservoir 89 to at least one of a shaft end 65a of the counter shaft 65 and a shaft end 66a of the drive shaft 66. The eighth oil passage 88 according to the embodiment of the present invention includes a first transmission lubricating-oil passage 91 for leading the lubricating oil from the reservoir 89 to the shaft end 65a of the counter shaft 65 and a second transmission lubricating-oil passage 92 for leading the lubricating oil from the reservoir 89 to the shaft end 66a of the drive shaft 66.

In addition, the engine 11 further includes a scavenging pump 95 as a recovery pump for pumping the lubricating oil accumulated at a bottom of the crank chamber 67 into the transmission chamber 68. The lubricating oil that has lubricated the crankshaft 47 and drips into the crank chamber 67 so as to be accumulated at the bottom of the crank chamber 67, and the same holds true for the lubricating oil that has cooled the piston 49.

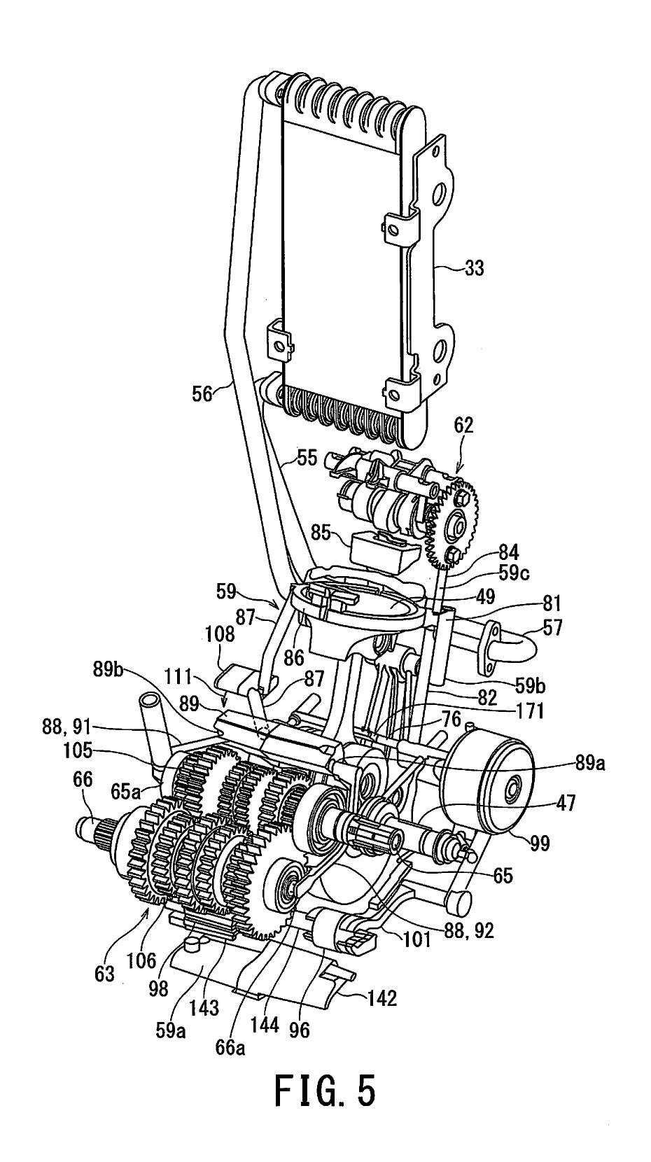

FIG. 5 is a schematic perspective view of the lubrication structure for the internal combustion engine according to the embodiment of the present invention.

As shown in FIG. 4 and FIG. 5, the engine 11 according to the embodiment of the present invention includes an oil pump 96 for sucking up the lubricating oil from the oil pan 61, and a first oil filter 98 for removing contaminants from the lubricating oil drawn into the oil pump 96, and a second oil filter 99 for removing contaminants discharged from the oil pump 96. The oil pump 96 and the second oil filter 99 are provided in the forward passage of the oil passage 59a of the crankcase 41.

The oil passage 59a of the crankcase 41 have a left side part that is provided in the left case half 51 and a right side part that is provided the right case half 52. The left side part and the right side part are connected to each other at the mating surface 41a of the crankcase 41.

The oil pump 96 is a feed pump that pressure-feeds the lubricating oil to the respective components to be lubricated. The oil pump 96 is disposed below the crankshaft 47. The oil pump 96 is driven by a non-illustrated auxiliary drive gear that rotates integrally with the crankshaft 47. The output of the oil pump 96 depends on the rotation speed of the crankshaft 47, i.e., the rotation speed of the engine 11. That is, as the rotation speed of the engine 11 increases, the oil pump 96 discharges more lubricating oil. By driving the oil pump 96, the lubricating oil in the oil pan 61 is drawn into the oil passage 59a of the crankcase 41. The oil pump 96 is connected to the second oil filter 99 via a pump-discharge-side oil passage 101. The pump-discharge-side oil passage 101 is a supply oil passage through which the lubricating oil is discharged from the oil pump 96. The lubricating oil drawn into the oil passage 59a of the crankcase 41 passes through the second oil filter 99 so as to have the contaminants removed.

The lubricating oil having passed through the second oil filter 99 reaches the shaft end 47a of the crankshaft 47 via the crankshaft lubricating-oil passage 75. Additionally, the lubricating oil having passed through the second oil filter 99 is injected to the piston 49 via the piston-cooling oil passage 76.

In addition, the lubricating oil having passed through the second oil filter 99 is cooled with the oil cooler 33 through the second oil passage 82 of the cylinder 42 and the oil hose 55. The lubricating oil cooled with the oil cooler 33 passes through the oil hose 56 and the third oil passage 83, and reaches the fifth oil passage 85 of the cylinder head 43. The lubricating oil having passed through the fifth oil passage 85 and cooled the exhaust port 69 flows into the sixth oil passage 86 so as to cool the combustion chamber 70. The lubricating oil having passed through the sixth oil passage 86 and cooled the combustion chamber 70 is returned from the seventh oil passage 87 to the crankcase 41.

Further, the lubricating oil having branched off at the cylinder 42 and flown into the first oil passage 81 flows upward in the cylinder 42 so as to reach the fourth oil passage 84 of the cylinder head 43 and lubricate the valve mechanism 62.

Furthermore, the lubricating oil having returned from the seventh oil passage 87 to the crankcase 41 is stored in the reservoir 89. A part of the lubricating oil stored in the reservoir 89 flows out from the reservoir 89 to the eighth oil passage 88. The lubricating oil passing through the first transmission lubricating-oil passage 91 of the eighth oil passage 88 reaches the shaft end 65a of the counter shaft 65. The lubricating oil having reached the shaft end 65a of the counter shaft 65 flows into a hole extending along the axis of the counter shaft 65 so as to lubricate the counter gear 105 that is rotatably supported by the counter shaft 65. The lubricating oil having lubricated the counter gear 105 drops (i.e., drips) in the transmission chamber 68 and returns to the oil pan 61.

The lubricating oil having passed through the second transmission lubricating-oil passage 92 of the eighth oil passage 88 reaches the shaft end 66a of the drive shaft 66. The lubricating oil having reached the shaft end 66a of the drive shaft 66 flows into a hole extending along the axis of the drive shaft 66 so as to lubricate the drive gear 106 that is rotatably supported by the drive shaft 66. The lubricating oil having lubricated the drive gear 106 drops (i.e., drips) in the transmission chamber 68 and returns to the oil pan 61.

In addition, a part of the lubricating oil stored in the reservoir 89 overflows from the reservoir 89 and drops directly into the transmission chamber 68. The lubricating oil dropped into the transmission chamber 68 is applied to the transmission 63 so as to lubricate the counter gear 105 and the drive gear 106, and further drops inside the transmission chamber 68 so as to return to the oil pan 61.

The oil passage 59 of the engine 11 may include a second reservoir 108 to be provided in the middle of at least one of the oil hose 56, the seventh oil passage 87, and the eighth oil passage 88. For instance, the oil passage 59 according to the embodiment of the present invention includes the second reservoir 108 provided in the middle of the seventh oil passage 87. The second reservoir 108 is connected to a ninth oil passage 111 that serves as a magneto cooling passage by leading the lubricating oil from the second reservoir 108 to a non-illustrated magneto.

The reservoir 89 of the oil passage 59 is disposed below the oil cooler 33. Thus, the lubricating oil flowing out of the oil cooler 33 flows down to the reservoir 89 via the oil hose 56 and the oil passage 59b of the cylinder 42. In other words, the lubricating oil flowing out of the oil cooler 33 reaches the reservoir 89 by the hydraulic head difference (i.e., water head difference) between the top of the oil cooler 33 and the reservoir 89. That is, it is sufficient that the oil pump 96 can lift the lubricating oil to the top of the oil cooler 33.

Among the shaft end 65a of the counter shaft 65 and the shaft end 66a of the drive shaft 66, the shaft end connected to the eighth oil passage 88 is(are) disposed below the reservoir 89. That is, in the oil passage 59 of the engine 11 according to the embodiment of the present invention, the shaft end 65a of the counter shaft 65 connected to the first transmission lubricating-oil passage 91 is disposed below the reservoir 89, and the shaft end 66a of the drive shaft 66 connected to the second transmission lubricating-oil passage 92 is also disposed below the reservoir 89. Thus, the lubricating oil flowing out of the reservoir 89 flows down to the shaft end 65a of the counter shaft 65 via the first transmission lubricating-oil passage 91, and further flows down to the shaft end 66a of the drive shaft 66 via the second transmission lubricating-oil passage 92. Since the reservoir 89 is open to the transmission chamber 68, the lubricating oil flowing out of the reservoir 89 reaches the shaft end 65a of the counter shaft 65 by the hydraulic head difference between the reservoir 89 and the shaft end 65a of the counter shaft 65, and further reaches the shaft end 66a of the drive shaft 66 by the hydraulic head difference between the reservoir 89 and the shaft end 66a of the drive shaft 66. That is, the discharge pressure of the oil pump 96 does not act on the shaft end 65a of the counter shaft 65 and the shaft end 66a of the drive shaft 66. In other words, the lubricating structure of the engine 11 does not require the discharge pressure of the oil pump 96 for supplying the lubricating oil to the shaft end 65a of the counter shaft 65 and the shaft end 66a of the drive shaft 66.

The reservoir 89 straddles both of the pair of right and left crankcase halves 52 and 51, extends in a gutter shape substantially over its entire width, and is open to the transmission chamber 68.

The eighth oil passage 88 leads the lubricating oil from one end 89a in the width direction of the reservoir 89 to the shaft end 65a of the counter shaft 65, and further leads the lubricating oil from another end 89b in the width direction of the reservoir 89 to the shaft end 66a of the drive shaft 66. That is, the first transmission lubricating-oil passage 91 of the eighth oil passage 88 leads the lubricating oil from the left end 89a of the reservoir 89 to the shaft end 65a of the counter shaft 65. The second transmission lubricating-oil passage 92 of the eighth oil passage 88 leads the lubricating oil from the right end 89b of the reservoir 89 to the shaft end 66a of the drive shaft 66.

The eighth oil passage 88 is inclined downward substantially over its entire length. That is, the first transmission lubricating-oil passage 91 is inclined downward over its entire length from the left end 89a of the reservoir 89 toward the shaft end 65a of the counter shaft 65. The second transmission lubricating-oil passage 92 is inclined downward over its entire length from the right end 89b of the reservoir 89 toward the shaft end 66a of the drive shaft 66.

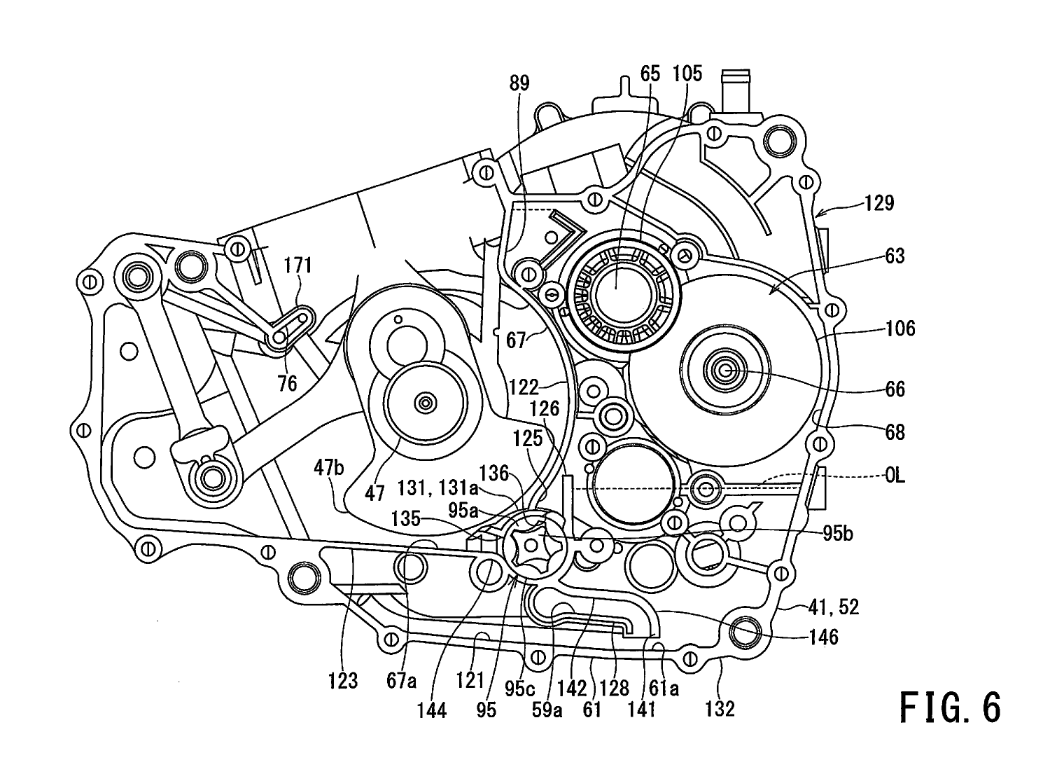

FIG. 6 is a cross-sectional view of the internal combustion engine according to the embodiment of the present invention, taken along the line VI-VI of FIG. 2.

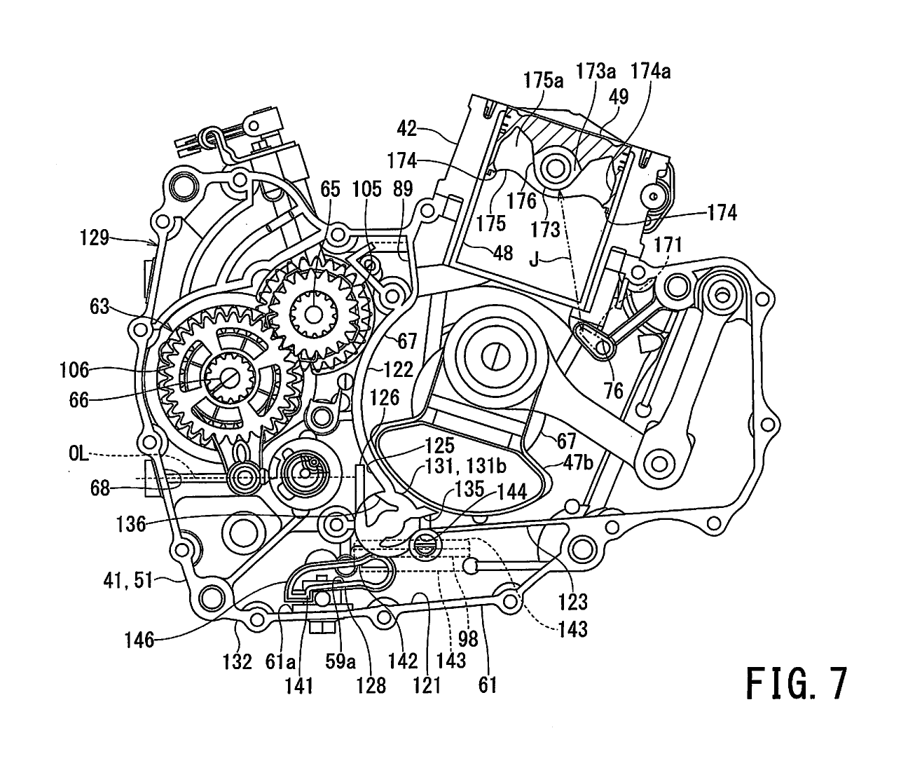

FIG. 7 is a cross-sectional view of the internal combustion engine according to the embodiment of the present invention, taken along the line VII-VII of FIG. 2.

Each of FIG. 6 and FIG. 7 corresponds to the cross-sectional view of the engine 11 on the mating surface 41a of the crankcase 41. In other words, FIG. 6 shows the right case half 52 as viewed from the side of the mating surface 41a and FIG. 7 shows the left case half 51 as viewed from the side of the mating surface 41a.

As shown in FIG. 6 and FIG. 7, the crankcase 41 of the engine 11 according to the embodiment of the present invention includes the oil pan 61, a first common partition wall 122, a second common partition wall 123, a discharge-oil-passage partition wall 126, and a plate body 128. The oil pan 61 includes an oil storage chamber 121 that is partitioned so as to across below the crank chamber 67 and below the transmission chamber 68 and stores the lubricating oil. The first common partition wall 122 separates the crank chamber 67 from the transmission chamber 68. The second common partition wall 123 separates the crank chamber 67 from the oil storage chamber 121. The discharge-oil-passage partition wall 126 is provided in the transmission chamber 68 and faces the first common partition wall 122 so as to partition a discharge oil passage 125. The plate body 128 extends from the first common partition wall 122 to the oil pan 61, and prevents movement of the lubricating oil between the lower portion of the crank chamber 67 and the lower portion of the transmission chamber 68 in the oil pan 61.

In addition, the crankcase 41 includes a breather chamber 129 configured to separate oil mist from blowby gas. In other words, the crankcase 41 partitions the breather chamber 129 in addition to the crank chamber 67 and the transmission chamber 68. The breather chamber 129 is disposed adjacent to the transmission chamber 68 and above the transmission chamber 68.

The entirety of the crankcase 41, the transmission case 45, the oil pan 61, and the plate body 128 can be divided into the pair of case halves 51 and 52 at the mating surface 41a orthogonal to the crankshaft 47.

The oil pan 61 is an oil reservoir integrated with the crankcase 41. The oil pan 61 partitions the oil storage chamber 121 that stores the lubricating oil. The oil storage chamber 121 is connected to the transmission chamber 68, and is separated from the crank chamber 67 by the second common partition wall 123.

The first common partition wall 122 is integrated with the crankcase 41. The first common partition wall 122 is shared by the crankcase 41 and the transmission case 45. In other words, one surface of the first common partition wall 122 is a part of the inner surface of the crank chamber 67, and the other surface of the first common partition wall 122 is a part of the inner surface of the transmission chamber 68. The first common partition wall 122 has a substantially uniform thickness (i.e., the distance between one face and the other face is substantially uniform). The first common partition wall 122 extends in an arc shape following an outer shape of a counterweight 47b of the crankshaft 47.

The second common partition wall 123 is integrated with the crankcase 41. The second common partition wall 123 is shared by the crankcase 41 and the oil pan 61. In other words, one surface of the second common partition wall 123 is a part of the inner surface of the crank chamber 67, and the other surface of the second common partition wall 123 is a part of the inner surface of the oil storage chamber 121. The second common partition wall 123 has a substantially uniform thickness (i.e., the distance between one surface and the other surface is substantially uniform).

The scavenging pump 95 is provided in the junction portion (i.e., confluence portion, connecting portion) between the first common partition wall 122 and the second common partition wall 123 and in the right case half 52. The scavenging pump 95 is housed in a scavenging pump housing 131 provided at the junction portion between the first common partition wall 122 and the second common partition wall 123.

The scavenging pump 95 is a so-called trochoid pump. The scavenging pump 95 includes an outer rotor 95a and an inner rotor 95b. The scavenging pump 95 directs the rotation center line of the outer rotor 95a and the inner rotor 95b in the width direction of the crankcase 41. In other words, the rotation center line of the outer rotor 95a and the inner rotor 95b, i.e., the rotation center line of the scavenging pump 95 is in parallel to the rotation center line of the crankshaft 47.

The scavenging pump 95 is closer to the inner surface of the bottom wall 132 of the oil pan 61 than the crank chamber 67, i.e., closer to the bottom surface 61a of the oil pan 61. The portion 95c of the scavenging pump 95 closest to the bottom surface 61a of the oil pan 61 is closer to the bottom surface 61a of the oil pan 61 than the portion 67a closest to the bottom surface 61a of the oil pan 61 in the crank chamber 67.

The scavenging pump housing 131 includes a pump accommodating portion 131a provided in the right case half 52 for accommodating the scavenging pump 95 and a pump accommodating lid 131b provided in the left case half 51 for closing the pump accommodating portion 131a. The scavenging pump housing 131 includes suction ports 135 connected to the crank chamber 67 and discharge ports 136 connected to the transmission chamber 68. Both end faces of the scavenging pump 95 face both the corresponding suction ports 135 and the corresponding discharge ports 136. The scavenging pump 95 sucks the lubricating oil from both end faces and discharges the lubricating oil from both end faces. The suction ports 135 cause the lubricating oil discharged from the corresponding end faces of the scavenging pump 95 to flow out in the radial direction of the scavenging pump 95. That is, the scavenging pump 95 sucks the lubricating oil from the radial direction and discharges the lubricating oil in the radial direction.

There are a pair of suction ports 135. One of the suction ports 135 is provided in the pump accommodating lid 131b of the left case half 51. The other of the suction ports 135 is provided in the pump accommodating portion 131a of the right case half 52. There are a pair of discharge ports 136. One of the discharge ports 136 is provided in the pump accommodating lid 131b of the left case half 51. The other of the discharge ports 136 is provided in the pump accommodating portion 131a of the right case half 52.

The suction ports 135 of the scavenging pump housing 131 are disposed at the rear end portion of the second common partition wall 123. The second common partition wall 123 is inclined downward toward the suction ports 135 of the scavenging pump housing 131. In other words, one surface of the second common partition wall 123, i.e., the surface on the side of the crank chamber 67 is inclined downward toward the suction ports 135 of the scavenging pump housing 131.

The discharge-oil-passage partition wall 126 faces the wall surface of the first common partition wall 122 on the side of the transmission chamber 68, i.e., the inner wall surface of the transmission chamber 68. The discharge-oil-passage partition wall 126 extends from the scavenging pump housing 131 in the height direction of the transmission chamber 68. The discharge-oil-passage partition wall 126 reaches the respective inner surfaces of the right and left side walls of the transmission chamber 68, and extends to the full width of the transmission chamber 68. In other words, the discharge-oil-passage partition wall 126 reaches the respective inner surfaces of the right and left side walls of the crankcase 41, and extends to the full width of the crankcase 41. The discharge oil passage 125 is defined between the discharge oil passage partition wall 126 and the first common partition wall 122. The discharge oil passage 125 is opened upward of the transmission chamber 68. That is, the discharge oil passage 125 is also an oil reservoir for which the discharge-oil-passage partition wall 126 serves as a bank (i.e., embankment, shield or barrier). The discharge oil passage 125 discharges the lubricating oil from the scavenging pump 95 to the transmission chamber 68. The bottom of the discharge oil passage 125 is connected to the discharge ports 136 of the scavenging pump 95. In other words, the scavenging pump 95 discharges the lubricating oil accumulated in the crank chamber 67 to the discharge oil passage 125 that communicates to the transmission chamber 68. The oil level OL of the lubricating oil stored in the oil pan 61 is slightly lower than the highest position of the discharge-oil-passage partition wall 126. The oil level OL does not touch the gear of the transmission 63 in the horizontal state.

The plate body 128 extends from the lower portion of the scavenging pump 95 toward the rear side of the crankcase 41. The plate body 128 is located directly below the transmission chamber 68, and extends substantially in the front half range of the depth (forward and backward dimension) of the transmission chamber 68. One of the outer surfaces of the plate body 128 faces the transmission chamber 68, and the other of the outer surfaces of the plate body 128 faces the bottom surface 61a of the oil pan 61.

The plate body 128 includes a suction port 141 for sucking the lubricating oil from the oil pan 61 and a filter-upstream-side oil passage 142 connected to the suction port 141 for circulating the lubricating oil.

The filter-upstream-side oil passage 142 is connected to the first oil filter 98. The filter-upstream-side oil passage 142 leads the lubricating oil sucked from the suction port 141 to the first oil filter 98.

The first oil filter 98 is provided on the left case half 51. The first oil filter 98 is disposed in the filter accommodating portion 143 that is opened to the left side of the left case half 51. The filter accommodating portion 143 is closed by the left case cover 53, i.e., the magneto cover. The filter accommodating portion 143 is connected to the filter-upstream-side oil passage 142. In addition, the filter accommodating portion 143 is connected to the oil pump 96 via a filter-downstream-side oil passage 144 that crosses the left case half 51 and the right case half 52.

The plate body 128 is separated from the bottom wall 132 of the oil pan 61. In other words, the bottom wall 132 of the oil pan 61 is separated from the wall 146 that is a part of the plate body 128 and partitions the filter-upstream-side oil passage 142. A gap between the bottom wall 132 of the oil pan 61 and the wall 146 partitioning the filter-upstream-side oil passage 142 is a part of the oil storage chamber 121 that stores the lubricating oil. Normally, this gap, i.e., the gap between the plate body 128 and the bottom wall 132 of the oil pan 61 is filled with the lubricating oil. This gap is narrower in the vertical direction of the engine 11 than the other portions of the oil storage chamber 121. In other words, this gap is substantially lower in ceiling height than the rest of the oil reservoir chamber 121.

The plate body 128 is closer to the bottom surface 61a of the oil pan 61 than the discharge oil passage 125. The plate body 128 is closer to the bottom surface 61a of the oil pan 61 than the scavenging pump housing 131. A rear end edge portion of the other outer surface of the plate body 128 is closest to the bottom wall 132 of the oil pan 61 as compared with the other portions of the plate body 128. This rear end edge portion is the lowest part in the oil storage chamber 121.

The portion of the oil storage chamber 121 on the side of the crank chamber 67 is the front half of the oil pan 61 bordering on the gap portion between the plate body 128 and the bottom surface 61a of the oil pan 61. The front half of the oil pan 61 is stepwisely lowered in ceiling height by the second common partition wall 123 that incline slightly backward and downward from the front side to the rear side of the crankcase 41, the portion that is lowered in ceiling height in an arc shape from the front side to the rear side of the crankcase 41 along the scavenging pump housing 131, and the plate body 128 extending from the scavenging pump housing 131. The boundary between the second common partition wall 123 and the scavenging pump housing 131 is lowered in ceiling height in an arc shape by the wall surface that partitions the filter-downstream-side oil passage 144.

The bottom surface of the oil storage chamber 121 on the side of the transmission chamber 68 is raised in a stepped manner by the wall surface that faces the upper portion of the transmission chamber 68 and corresponds to the ceiling of the plate body 128.

The plate body 128 reaches the corresponding inner surfaces of the right and left side walls of the oil storage chamber 121 and extends to the full width of the oil storage chamber 121. In other words, the plate body 128 reaches the corresponding inner surfaces of the right and left side walls of the crankcase 41 and substantially extends to the full width of the crankcase 41.

The filter-upstream-side oil passage 142 also reaches the corresponding inner surfaces of the right and left side walls of the oil storage chamber 121 and extends to the full width of the oil storage chamber 121. In other words, the filter-upstream-side oil passage 142 reaches the corresponding inner surfaces of the right and left side walls of the crankcase 41 and substantially extends to the full width of the crankcase 41.

The suction port 141 of the filter-upstream-side oil passage 142 is provided in the center portion in the width direction of the crankcase 41. That is, the suction port 141 straddles the mating surface 41a of the left case half 51 and the right case half 52. The suction port 141 corresponds to the entrance of the entire oil passage 59 for sucking the lubricating oil from the oil storage chamber 121 into the oil passage 59. The suction port 141 is directed to the bottom surface 61a of the oil pan 61, i.e., the inner surface of the bottom wall 132 of the oil pan 61. The suction port 141 is disposed at the rear end edge portion of the other outer surface of the plate body 128, which rear end edge portion faces the bottom surface 61a of the oil pan 61. The suction port 141 is provided at the center portion of the rear end edge portion of the other outer surface of the plate body 128, which center portion is the portion closest to the bottom wall 132 of the oil pan 61 as compared with the other portions of the plate body 128.

The lubricating oil stored in the oil storage chamber 121 causes liquid level fluctuation (i.e., sloshing) due to acceleration and deceleration of the motorcycle 1 on which the engine 11 is mounted. When the motorcycle 1 accelerates, the lubricating oil moves to the rear of the engine 11, i.e., to the side of the transmission chamber 68. When the motorcycle 1 decelerates, the lubricating oil moves to the front of the engine 11, i.e., to the side of the crank chamber 67. When gears of the transmission 63 are submerged in the lubricating oil by the liquid level fluctuation, the gears of the transmission 63 agitate the lubricating oil and eventually become the resistance against the rotation of the gears. Further, when the suction port 141 corresponding to the entrance of the oil passage 59 is exposed to the outside of the oil surface due to the liquid level fluctuation, supply of the lubricating oil to the components to be lubricated may be temporarily cut off.

For this reason, the engine 11 according to the embodiment of the present invention includes the plate body 128 in the lubricating oil of the oil storage chamber 121. The gap between the plate body 128 and the bottom wall 132 of the oil pan 61 is located in the oil storage chamber 121, connects the portion of the oil storage chamber 121 directly below the crank chamber 67 to the portion of the oil storage chamber 121 directly below the transmission chamber 68, is lower in ceiling height than both portions, and narrows (squeezes) a flow passage area of the flow passage through which the lubricating oil. Thus, the flow of the lubricating oil in the oil storage chamber 121, which is caused by the acceleration or deceleration of the motorcycle 1, particularly the flow of the lubricating oil between the portion directly below the crank chamber 67 and the portion directly below the transmission chamber 68, is suppressed by the gap between the plate body 128 and the bottom wall 132 of the oil pan 61. The effect of suppressing the flow of the lubricating oil between the portion directly beneath the crank chamber 67 and the portion directly beneath the transmission chamber 68 retards and suppresses the liquid level fluctuation in the oil storage chamber 121.

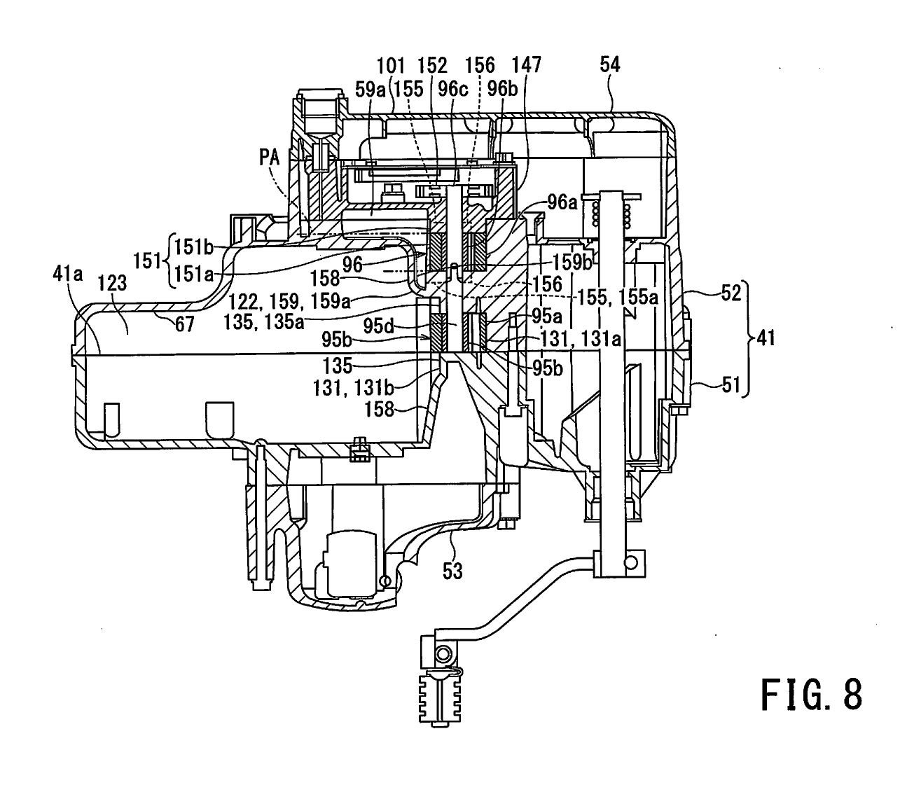

FIG. 8 is a cross-sectional view of the internal combustion engine according to the embodiment of the present invention, taken along the line VIII-VIII of FIG. 3.

FIG. 8 is a cross-sectional view passing through the rotation center line of the scavenging pump 95.

As shown in FIG. 8, the crankcase 41 of the engine 11 according to the embodiment of the present invention includes an oil block 147 provided on the right side surface of the right case half 52.

The oil block 147 cooperates with the right case half 52 so as to partition the oil passage 59a of the crankcase 41. The oil block 147 is covered with the right case cover 54.

The oil pump 96 and the scavenging pump 95 are provided in one of the right and left crankcase halves 52 and 51, e.g., in the right case half 52 in the case of the present embodiment. The right case half 52 has a pair of pump accommodating portions 131a and 151a for accommodating the oil pump 96 and the scavenging pump 95, respectively. The pump accommodating portions 131a and 151a are open in mutually opposite directions in the direction of the rotation center line of the crankshaft 4.

The oil pump 96 is provided in the junction portion (i.e., confluence portion, connecting portion) between the first common partition wall 122 and the second common partition wall 123 and in the right case half 52. The oil pump 96 is accommodated in an oil pump housing 151 provided at the junction portion between the first common partition wall 122 and the second common partition wall 123.

The oil pump 96 is a so-called trochoid pump, similarly to the scavenging pump 95. The oil pump 96 includes an outer rotor 96a and an inner rotor 96b. The oil pump 96 directs the rotation center line of the outer rotor 96a and the inner rotor 96b in the width direction of the crankcase 41. In other words, the rotation center line of the outer rotor 96a and the inner rotor 96b, i.e., the rotation center line of the oil pump 96 is in parallel to the rotation center line of the crankshaft 47. The rotation shaft 96c of the oil pump 96 and the rotation shaft 95d of the scavenging pump 95 are coaxial and integrated. One shaft end of the integrated rotation shaft 96c and 95d protrudes rightward from the right side surface of the right case half 52 and rightward from the right side surface of the oil block 147. At one axial end of the integrated rotation shaft 96c and 95d, there is provided an auxiliary driven gear 152 that is meshed with the auxiliary drive gear rotationally integrated with the crankshaft 47.

The oil pump housing 151 includes a pump accommodating portion 151a provided in the right case half 52 for accommodating the oil pump 96 and a pump accommodating lid 151b provided in the oil block 147 for closing the pump accommodating portion 151a. The oil pump housing 151 includes suction ports 155 connected to the first oil filter 98 and discharge ports 156 connected to the second oil filter 99.

The oil pump housing 151 includes a pair of suction ports 155. One of the suction ports 155 is provided in the pump accommodating lid 151b of the oil block 147. The other of the suction ports 155 is provided in the pump accommodating portion 151a of the right case half 52. There are a pair of discharge ports 156. One of the discharge ports 156 is provided in the pump accommodating lid 151b of the oil block 147. The other of the discharge ports 156 is provided in the pump accommodating portion 151a of the right case half 52. Both end faces of the oil pump 96 face both the corresponding suction ports 155 and the corresponding discharge ports 156. The oil pump 96 sucks the lubricating oil from both end faces and discharges the lubricating oil from both end faces. The suction ports 155 allow the lubricating oil discharged from the corresponding end faces of the oil pump 96 to flow out in the radial direction of the oil pump 96. That is, the oil pump 96 sucks the lubricating oil from the radial direction and discharges it in the radial direction.

The suction ports 135 of the scavenging pump housing 131 are disposed at the center portion of the rear end portion of the crank chamber 67. In other words, the crank chamber 67 includes the suction ports 135 through which the lubricating oil is sucked from the guide oil passage 158 to the scavenging pump 95.

The bottom portion of the crank chamber 67 is the guide oil passage 158 for leading the lubricating oil accumulated in the crank chamber 67 to the scavenging pump 95. The guide oil passage 158 is inclined downward toward the suction ports 135 of the scavenging pump 95 and narrows in width (dimension in the width direction of the crankcase) toward the suction ports 135 of the scavenging pump 95.

The crankcase 41 includes a partition wall 159 that separates the pump-discharge-side oil passage 101 from the guide oil passage 158 by a pair of front and back wall surfaces 159a and 159b. The partition wall 159 is provided on the right case half 52. That is, the crankcase 41 partitions the pump-discharge-side oil passage 101 through which the lubricating oil discharged from the oil pump 96 flows through and the guide oil passage 158 which leads the lubricating oil to the scavenging pump 95 side by side on the front and back sides of the partition wall 159.

The partition wall 159 is engaged with a projection area PA of the oil pump 96 toward the crank chamber 67. As the partition wall 159 approaches the scavenging pump 95, the partition wall 159 bends toward the transmission chamber 68 and reaches the suction port 135. The partition wall 159 has a substantially uniform plate thickness.

The wall surface 159a on the side of the crank chamber 67 is a part of the inner wall surface of the crank chamber 67 defining the guide oil passage 158. The wall surface 159a approaches the oil pump 96 in the direction substantially orthogonal to the rotation center line of the oil pump 96, and changes its direction while forming an arc shape toward the mating surface 41a of the crankcase 41. As the wall surface 159a goes out of the projection area PA and approaches the mating surface 41a, the wall surface 159a approaches the rear end edge of the crank chamber 67 while forming an arc shape, and finally reaches the suction port 135a connected to the end face of the scavenging pump 95 on the side close to the oil pump 96, out of the pair of suction ports 135.

The wall surface 159b is a part of the wall surface of the right case half 52 that partitions the pump-discharge-side oil passage 101. The wall surface 159b separates from the suction port 155a connected to the end face of the oil pump 96 on the side closer to the scavenging pump 95, out of the pair of suction ports 155, in the radial direction of the oil pump 96 while forming an arc shape. The wall surface 159b extends in a direction away from the mating surface 41a of the crankcase 41 so as to enter the projection area PA. As the wall surface 159b further separates away from the mating surface 41a, the wall surface 159b changes its direction in the radial direction of the oil pump 96 while forming an arc shape, so as to separate from the oil pump 96.

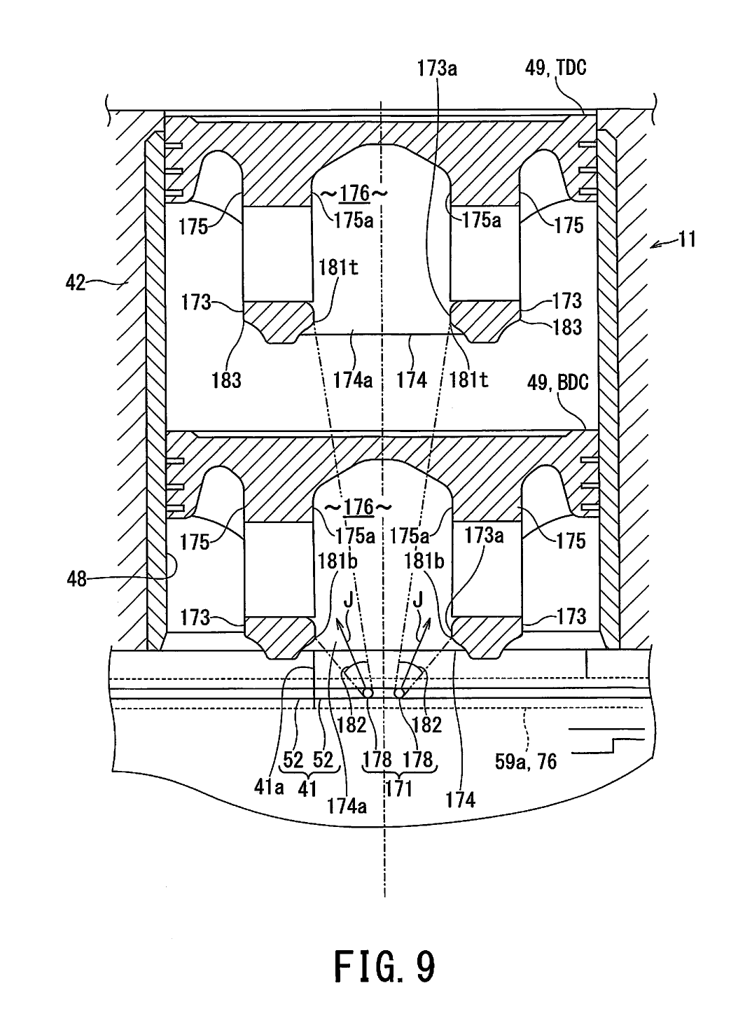

FIG. 9 is a schematic view illustrating relationship between a piston and a piston jet of the internal combustion engine according to the embodiment of the present invention.

In addition to FIG. 4 to FIG. 7, as shown in FIG. 9, the engine 11 according to the embodiment of the present invention includes a piston jet 171 as an oil injector that injects the lubricating oil to the piston 49. Note that FIG. 9 schematically depicts both the case where the head of the piston 49 is at the top dead center TDC and the case where the head of the piston 49 is at the bottom dead center BDC. In other words, though two pistons 49 are described in FIG. 9 for the respective positions of the piston 49 in terms of reciprocating motion, there is only one piston 49 in the cylinder 42.

The piston 49 includes a pair of pin bosses 173, a pair of skirts 174, and a pair of side walls 175 that connects the pin bosses 173 to the skirts 174. The pair of pin bosses 173 are opposed to (i.e., face) each other, the pair of skirts 174 face each other, and the pair of side walls 175 face each other. In addition, the piston 49 includes a piston inner region 176 surrounded by inner surfaces 173a of the corresponding pin bosses 173, inner surfaces 174a of the corresponding skirts 174, and inner surfaces 175a of the corresponding side walls 175.

The oil passage 59a of the crankcase 41 is connected to the piston jet 171.

The piston jet 171 includes a pair of oil injection holes 178 for injecting the lubricating oil to the corresponding pin bosses 173. The pair of oil injection holes 178 are arranged in a region sandwiched between the pair of pin bosses 173 so as to be symmetrical with respect to the center line of the cylinder bore 48. The pair of oil injection holes 178 are processed holes directly bored in the crankcase 41.

When the piston 49 is moved to the top dead center TDC by the reciprocating motion, the piston jet 171 injects the lubricating oil to the pin bosses 173. When the piston 49 is moved to the bottom dead center BDC by the reciprocating motion, the piston jet 171 injects the lubricating oil to the piston inner region 176. More specifically, one of the oil injection holes 178 of the piston jet 171 injects the lubricating oil to one of the pin bosses 173 when the piston 49 is at the top dead center TDC, and injects the lubricating oil to the piston inner region 176 when the piston 49 is at the bottom dead center BDC. The other of the oil injection holes 178 of the piston jet 171 injects the lubricating oil to the other one of the pin bosses 173 when the piston 49 is at the top dead center TDC, and injects the lubricating oil to the piston inner region 176 when the piston 49 is at the bottom dead center BDC. That is, the piston jet 171 can inject the lubricating oil to one of the pair of pin bosses 173 and the piston inner region 176 by using one oil injection hole 178.

The injection direction J of the lubricating oil of the piston jet 171 is oriented to the piston inner region 176 more than the pair of skirts 174. That is, the injection direction J of the lubricating oil of the piston jet 171 faces the piston inner region 176 other than the pair of skirts 174 regardless of whether the piston 49 is at the top dead center TDC or at the bottom dead center BDC.

Focusing on each side of the pair of oil injection holes 178, the injection direction J of the lubricating oil of the piston jet 171 is oriented to the injection area 182 sandwiched between the inner edge 181t of the pin boss 173 of the piston 49 at the top dead center TDC and the inner edge 181b of the pin boss 173 of the piston 49 at the bottom dead center BDC. When the piston 49 is at the top dead center TDC, the lubricating oil injected in the injection direction J is injected to the region outside the inner edge 181t of the pin boss 173, i.e., outside the piston inner region 176. When the piston 49 is at the bottom dead center BDC, the lubricating oil injected in the injection direction J is injected to the region inside the inner edge 181b of the pin boss 173, i.e., the piston inner region 176. When the piston 49 reciprocates between the top dead center TDC and the bottom dead center BDC, such an injection direction J alternately injects the lubricating oil to the pin boss 173 and the piston inner region 176 so as to cool and lubricate both of the piston inner region 176 and the pin boss 173 in addition to the region between both.

Focusing on each side of the pair of oil injection holes 178, the extended line of the straight line connecting the oil injection hole 178 and the inner edge 181b of the pin boss 173 of the piston 49 at the bottom dead center BDC preferably reaches the outer edge 183 of the pin boss 173 of the piston 49 at the top dead center TDC or the outside of the outer edge 183. In addition, the injection angle of the lubricating oil of the piston jet 171 may spread outside the injection region 182. In other words, the injection angle of the lubricating oil of the piston jet 171 may include the injection region 182.

Further, it is desirable that the injection angle of the lubricating oil of the piston jet 171 is as narrow as possible. The narrower the injection angle is, the more intensively the lubricating oil can be injected to the target region.

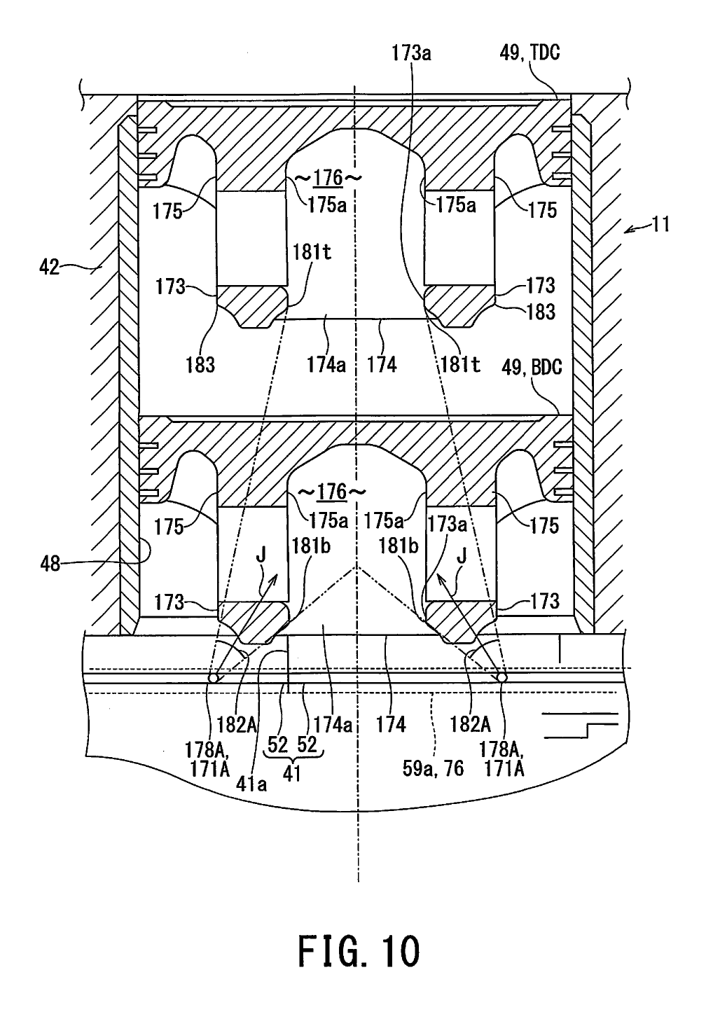

FIG. 10 is a schematic view illustrating relationship between the piston and another aspect of the piston jet of the internal combustion engine according to the embodiment of the present invention, in a manner similar to FIG. 9.

In the other aspect of the piston jet 171A, the same reference signs are assigned to the same components as those of the piston jet 171 shown in FIG. 9, and duplicate description is omitted.

As shown in FIG. 10, the piston jet 171A of the engine 11 according to the embodiment of the present invention includes a pair of oil injection holes 178A that inject the lubricating oil to the corresponding pin bosses 173. The pair of oil injection holes 178A are arranged outside the region sandwiched between the pair of pin bosses 173 so as to be symmetrical with respect to the center line of the cylinder bore 48.

Focusing on each side of the pair of oil injection holes 178A, when the piston 49 is at the bottom dead center BDC, the piston jet 171A injects the lubricating oil to the pin boss 173. When the piston 49 is at the top dead center TDC, the piston jet 171A injects the lubricating oil to the piston inner region 176. More specifically, one of the oil injection holes 178A of the piston jet 171A injects the lubricating oil to one of the pin bosses 173 when the piston 49 is at the bottom dead center BDC, and injects the lubricating oil to the piston inner region 176 when the piston 49 is at the top dead center TDC. The other of the oil injection holes 178A of the piston jet 171A injects the lubricating oil to the other of the pin bosses 173 when the piston 49 is at the bottom dead center BDC, and injects the lubricating oil to the piston inner region 176 when the piston 49 is at the top dead center TDC. That is, the piston jet 171A can inject the lubricating oil to one of the pair of pin bosses 173 and the piston inner region 176 by using one oil injection hole 178A.

Focusing on each side of the pair of oil injection holes 178A, the injection direction J of the lubricating oil of the piston jet 171A is oriented to the injection area 182A sandwiched between the inner edge 181t of the pin boss 173 of the piston 49 at the top dead center TDC and the inner edge 181b of the pin boss 173 of the piston 49 at the bottom dead center BDC. When the piston 49 is at the top dead center TDC, the lubricating oil injected in the injection direction J is injected to the region inside the inner edge 181t of the pin boss 173, i.e., the piston inner region 176. When the piston 49 is at the bottom dead center BDC, the lubricating oil injected in the injection direction J is injected to the region outside the inner edge 181b of the pin boss 173, i.e., the region outside the piston inner region 176. When the piston 49 reciprocates between the top dead center TDC and the bottom dead center BDC, such an injection direction J alternately injects the lubricating oil to the pin boss 173 and the piston inner region 176 so as to cool and lubricate both of the pin boss 173 and the piston inner region 176 in addition to the region between both.

The straight line connecting the oil injection hole 178A and the inner edge 181t of the pin boss 173 of the piston 49 at the top dead center TDC preferably passes through the outer edge 183 of the pin boss 173 of the piston 49 at the bottom dead center BDC or the outside of the outer edge 183. In addition, the injection angle of the lubricating oil of the piston jet 171A may spread outside the injection area 182A. In other words, as shown in FIG. 9 and FIG. 10, the piston jets 171 and 171A according to the embodiment of the present invention inject the lubricating oil to the pin bosses 173 when the piston 49 is at one of the top dead center TDC and the bottom dead center BDC, and inject the lubricating oil to the piston inner region 176 when the piston 49 is at the other of the top dead center TDC and the bottom dead center BDC.

Next, the breather chamber 129 of the engine 11 will be described in detail.

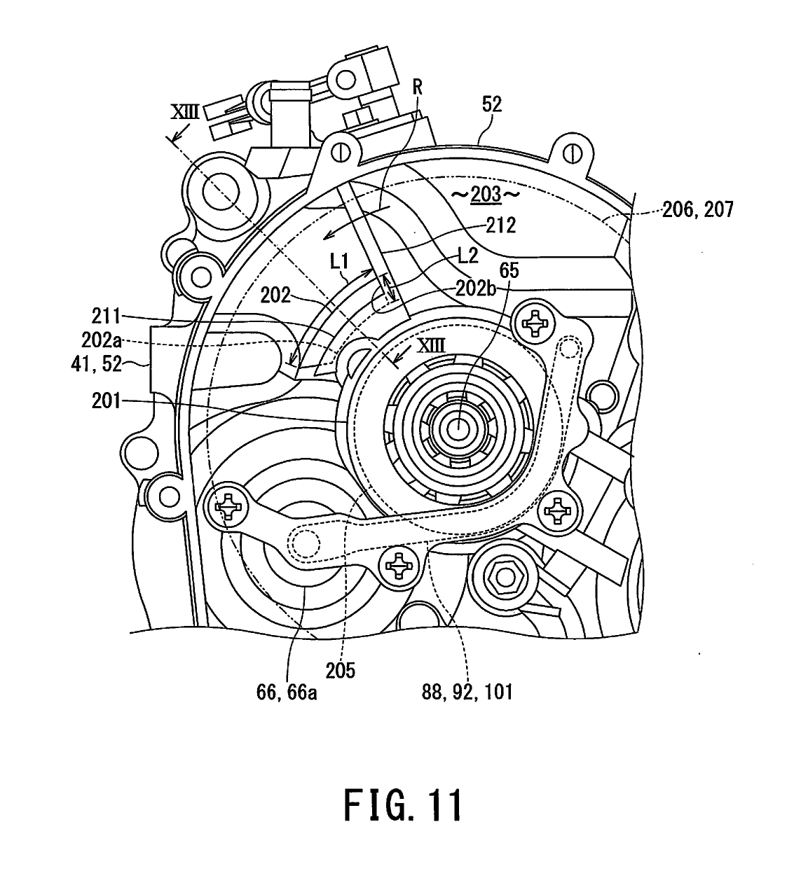

FIG. 11 is a partially enlarged view of the right side surface of the right case half of the internal combustion engine according to the embodiment of the present invention.

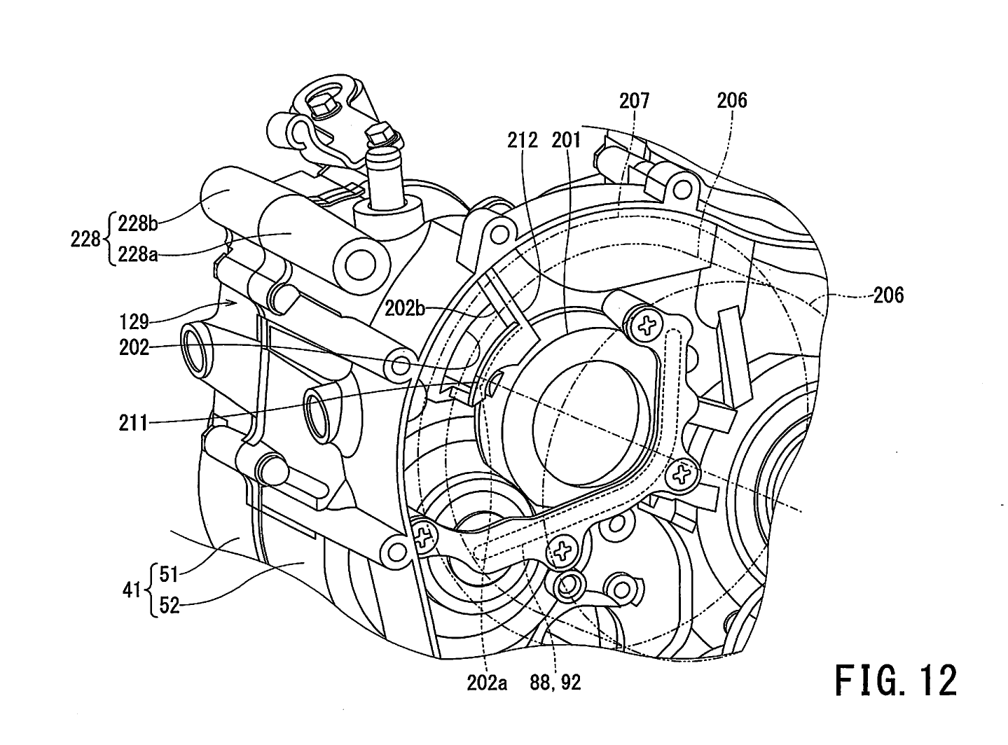

FIG. 12 is a perspective view of a part of a clutch chamber of the internal combustion engine according to the embodiment of the present invention.

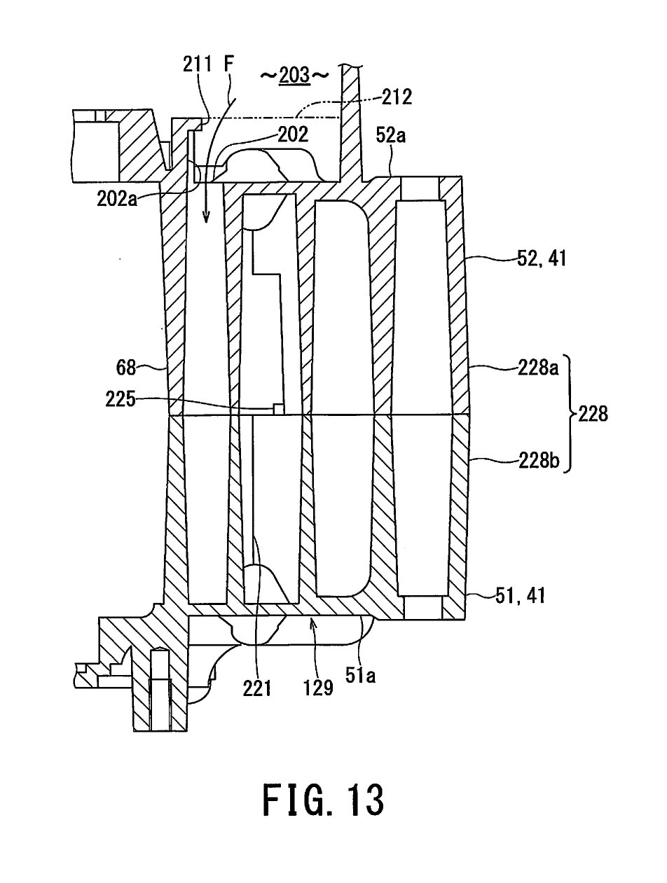

FIG. 13 is a cross-sectional view of a blowby-gas inlet port of the internal combustion engine according to the embodiment of the present invention, taken along line XIII-XIII of FIG. 11.

As shown in FIG. 11 to FIG. 13, the crankcase 41 of the engine 11 according to the embodiment of the present invention includes a bearing housing 201 and a blowby-gas inlet port 202.

The bearing housing 201 and the blowby-gas inlet port 202 are provided in a portion of the wall of the right case half 52 to be covered with the right case cover 54, i.e., provided in a portion inside the clutch chamber 203.

The bearing housing 201 holds, i.e., supports the bearing 205. The bearing 205 rotatably supports the counter shaft 65. The bearing housing 201 and the bearing 205 rotatably support a clutch 206 and a primary driven gear 207 via the counter shaft 65.

The primary driven gear 207 is rotatably provided on the counter shaft 65. On the crankshaft 47, a non-illustrated primary drive gear is rotatably provided. The primary drive gear is meshed with the primary driven gear 207 of the countershaft 65 on a steady basis. The primary driven gear 207 connects (engages) rotational force to the counter shaft 65 by the connection of the clutch 206 or disconnects (disengages) the rotational force from the counter shaft 65 by disconnecting (i.e., interrupting) the clutch 206.

The clutch 206 is provided at the shaft end portion of the counter shaft 65. The clutch 206 connects or disconnects the rotation (rotational driving force) between the crankshaft 47 and the counter shaft 65. The clutch 206 integrates or separates the rotation of the counter shaft 65 and the primary driven gear 207 so as to connect or disconnect the rotation (rotational driving force) between the crankshaft 47 and the counter shaft 65.

The clutch 206 and the primary driven gear 207 are housed in the clutch chamber 203. That is, the clutch 206 and the primary driven gear 207 are disposed outside the breather chamber 129. The clutch 206 and the primary driven gear 207 are rotating bodies that rotate around the counter shaft 65. That is, the respective rotation center lines of the clutch 206, the primary driven gear 207, and the counter shaft 65 substantially coincide.

The blowby-gas inlet port 202 is a flow passage for blowby gas connecting the clutch chamber 203 and the breather chamber 129. The blowby-gas inlet port 202 causes the blowby gas to flow from the clutch chamber 203 to the breather chamber 129 as shown by the solid arrow F in FIG. 13.

The blowby-gas inlet port 202 is a part of the periphery of the bearing housing 201, and is disposed at a position covered with the clutch 206 and the primary driven gear 207 as viewed from the direction along the rotation center line of the counter shaft 65 (see, e.g., FIG. 11). The blowby-gas inlet port 202 has a partially annular shape (arc shape) following the outer peripheral shape of the bearing housing 201. A radial opening dimension L2 of the blowby-gas inlet port 202 is smaller than a circumferential opening dimension L1 of the partial annular ring of the blowby-gas inlet port 202.

The second transmission lubricating-oil passage 92 for leading the lubricating oil from the reservoir 89 to the shaft end 66a of the drive shaft 66 bypasses the lower edge of the bearing housing 201, while the blowby-gas inlet port 202 is located above the bearing housing 201. In other words, the bearing housing 201 is sandwiched between the blowby-gas inlet port 202 disposed above and the second transmission lubricating-oil passage 92 disposed below.

When the clutch 206 and the primary driven gear 207 rotate, the lubricating oil supplied from the second transmission lubricating-oil passage 92 to the shaft end 65a of the counter shaft 65 is also used for lubrication of the clutch 206 and the primary driven gear in addition to lubrication of the transmission 63. The lubricating oil having lubricated the clutch 206 and the primary driven gear 207 is splashed into the clutch chamber 203 by the rotation of the clutch 206 and the primary driven gear 207.

Splashes of the lubricating oil splashed from the clutch 206 and the primary driven gear 207 are imparted with the velocity component in the rotational center line direction of the counter shaft 65 and the velocity component in the circumferential direction (i.e., rotational direction) of the clutch 206 and the primary driven gear 207. Those velocity components are caused by a non-illustrated recess, a non-illustrated weight reduction port formed in the clutch 206 and the primary driven gear 207, and a non-flat shape portion such as a non-illustrated spring for buffering the impact between the clutch 206 and the primary driven gear 207. Thus, the splashes of the lubricating oil splashed from the clutch 206 and the primary driven gear 207 splashes radially outward from the clutch 206 and the primary driven gear 207, while diffusing in the rotational center line direction (i.e., axial direction) of the counter shaft 65 and in the circumferential direction (i.e., rotational direction). Consequently, a part of the splashes of the lubricating oil contained in the blowby gas flows toward the blowby-gas inlet port 202.

For this reason, the crankcase 41 of the engine 11 according to the embodiment of the present invention includes a flange 211 that is provided integrally with the crankcase 41 so as to protrude from the bearing housing 201 and covers at least a part of the blowby-gas inlet port 202 as viewed from the direction along the rotation center line of the clutch 206 and the primary driven gear 207.

The flange 211 covers a portion of the opening edge of the blowby-gas inlet port 202 being close to the bearing housing 201, i.e., covers a partially annular inner diameter side 202a. The flange 211 preferably extends over the entire width of the inner diameter side 202a of the blowby-gas inlet 202 (the entire length in the circumferential direction of the bearing housing 201). The flange 211 may cover the entirety of the blowby-gas inlet port 202. However, in the case of a cast crankcase 41, it is preferable that the flange 211 is not larger than the outer diameter side of the blowby-gas inlet port 202.

Further, the crankcase 41 includes a shield (i.e., barrier guard bank or embankment) 212. The shield 212 is provided integrally with the crankcase 41, extends in the radial direction of the bearing housing 201 along the front side 202b in the rotational direction (as shown by the solid line arrow R in FIG. 11) of the clutch 206 and the primary driven gear 207 in the opening edge of the blowby-gas inlet 202, and protrudes from the crankcase 41 toward the clutch 206 and the primary driven gear 207.

The shield 212 extends from the bearing housing 201 and reaches the edge of the crankcase 41. In other words, the shield 212 has one end portion that abuts against the bearing housing 201 and the other end portion that abuts against the edge of the crankcase 41. The shield 212 extends so as to follow the virtual straight line that passes through the center of the bearing housing 201, i.e., the rotation center line of the clutch 206 and the primary driven gear 207 and extends in the radial direction of the bearing housing 201.

The shield 212 preferably extends over the entire length of the front side 202b of the blowby-gas inlet port 202. The shield 212 may be separated from the bearing housing 201 or may be separated from the edge of the crankcase 41. The shield 212 may be inclined with respect to the virtual straight line passing through the center of the bearing housing 201 and extending in the radial direction of the bearing housing 201 or may be curved.

The flange 211 and the shield 212 are formed integrally with the crankcase 41. In the case of the casting crankcase 41, the flange 211 and the shield 212 are integrally formed with the crankcase 41 by a mold. In other words, the blowby-gas inlet port 202, the flange 211, and the shield 212 are formed in the crankcase 41 by a mold. The flange 211 and the shield 212 are formed integrally with the crankcase 41 without using fastening components such as screws as in a breather plate in a conventional engine.

The flange 211 and the shield 212 prevent splashing of the lubricating oil splashed due to the rotation of the clutch 206 and the primary driven gear 207 from directly jumping in (i.e., flowing into) the blowby-gas inlet port 202 together with the blowby gas. Splashes of the lubricating oil scatters radially outwardly of the clutch 206 and the primary driven gear 207 and diffuses in the axial direction and the circumferential direction of the counter shaft 65. The flange 211 and the shield 212 function as house eaves or a hat collar to block splashes of the splashing lubricating oil, and prevents the splashes of the lubricating oil from jumping into the blowby-gas inlet port 202. The flange 211 exclusively shields splashes of the lubricating oil diffusing in the axial direction, and the shield 212 exclusively shields splashes of the lubricating oil diffusing in the circumferential direction.

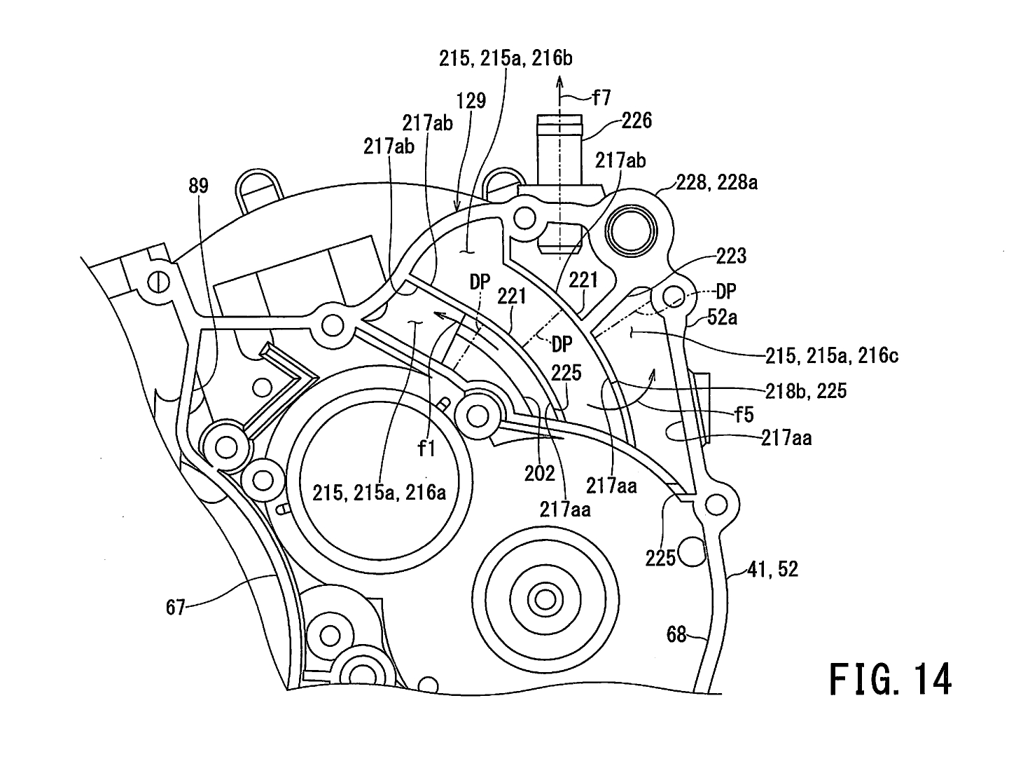

FIG. 14 is an enlarged view of a part of FIG. 6 for illustrating the breather chamber of the internal combustion engine according to the embodiment of the present invention.

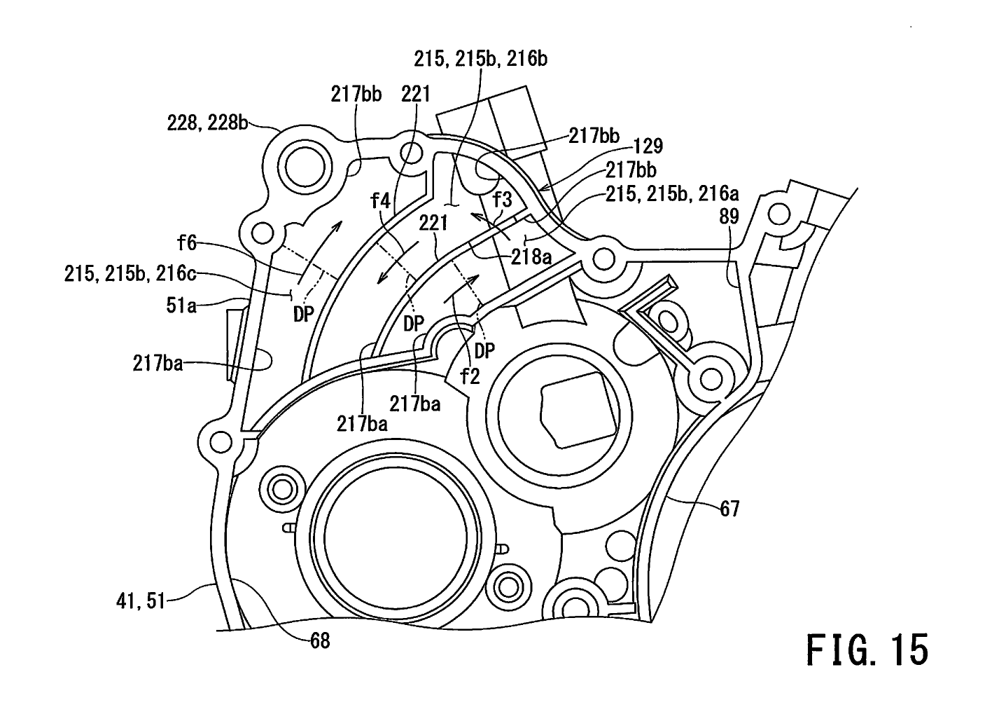

FIG. 15 an enlarged view of a part of FIG. 7 for illustrating the breather chamber of the internal combustion engine according to the embodiment of the present invention.

In addition to FIG. 13, as shown in FIG. 14 and FIG. 15, the breather chamber 129 of the engine 11 according to the embodiment of the present invention has a so-called labyrinth structure. That is, the breather chamber 129 has plural small chambers 215 that are partitioned across the right case half 52 and the left case half 51.

The plural small chambers 215 include a first small chamber 216a connected to the blowby-gas inlet port 202, a second small chamber 216b connected to the first small chamber 216a, and a third small chamber 216c connected to the second small chamber 216b.

Each of the small chambers 215 is partitioned between the right case half 52 and the left case half 51. That is, each of the small chambers 215 includes a portion partitioned by the right case half 52 and a portion partitioned by the left case half 51, with the coupling surface 41a of the crankcase 41 as the boundary between both portions. A partial small chamber 215a on the side of the right case half 52 is opened toward the left case half 51, and a partial small chamber 215b on the side of the left case half 51 is opened toward the right case half 52.

Here, a virtual dividing plane DP is defined such that the dividing plane DP partitions (i.e., bisects) the partial small chamber 215a and the partial small chamber 215b, intersects the mating surface 41a that is the boundary between the partial small chamber 215a and the partial small chamber 215b, extends in the direction of the adjacent small chambers 215. By using the dividing plane DP for the border (i.e., reference), one side of the divided small chamber 215a is defined as one corner 217aa of the partial small chamber 215a and the other side is defined as the other corner 217ab of the partial small chamber 215a. Further, by using the dividing plane DP for the border (i.e., reference), one side of the divided partial small chamber 215b is defined as one corner 217ba of the partial small chamber 215b, and the other side is defined as the other corner 217bb of the partial small chamber 215b. In other words, each of the small chambers 215 has a pair of partial small chambers 215a and 215b, and has four corners 217aa, 217ab, 217ba, and 217 bb.

The shape of each small chamber 215 is not limited to a rectangle, and may be a polygon including a triangle and a trapezoid, a circle, and an ellipse. The small chambers 215 having these shapes are also partitioned into four regions with reference to the virtual dividing plane DP intersecting the mating surface 41a, and these partitioned regions are referred to as corners.

In order to facilitate understanding of the arrangement of the corners 217aa, 217ab, 217ba, and 217bb in the present embodiment, the corner 217aa is referred to as the lower right corner 217aa, the corner 217ab is referred to as the upper right corner 217ab, the corner 217ba is referred to as the lower left corner 217ba, and the corner 217bb is referred to as the upper left corner 217bb. However, the directionality of each of the small chambers 215 is not limited to the above-described aspect, and the respective corners 217aa, 217ab, 217ba, and 217bb may be divided in the front-rear direction or may be divided obliquely with respect to the horizontal plane or the vertical plane.

The blowby-gas inlet port 202 is connected to the lower right corner 217aa of the first small chamber 216a (i.e., one corner 217aa on the side of the right case half 52). The first small chamber 216a and the second small chamber 216b are connected to each other at the upper left corner 217bb (i.e., the other corner 217bb on the side of the left case half 51). The second small chamber 216b and the third small chamber 216c are connected to each other at the lower right corner 217aa (i.e., one corner 217aa on the side of the right case half 52). That is, each of the small chambers 215 is connected to the small chamber 215 on the upstream side at a certain corner, and connected to the small chamber 215 on the downstream side through the central portion of the small chamber 215 or at the corner diagonally facing across the central part of the small chamber 215.

In other words, the breather chamber 129 includes a first blowby-gas flow port 218a connecting the upper left corner 217bb of the second small chamber 216b and the first small chamber 216a, and a second blowby-gas flow port 218b connecting the lower right corner 217aa of the third small chamber 216c and the second small chamber 216b. The breather chamber 129 passes blowby gas in a zigzag manner while passing through the central portion of each of the small chambers 215. Such a zigzag flow path can acquire a longer flow path length in a limited volume.

The plural small chambers 215 are partitioned by curved partition walls 221. There are plural partition walls 221 facing each small chamber 215. The plural small chambers 215 are arranged in a layered manner away from the center of the sector from the first small chamber 216a on the upstream side close to the blowby-gas inlet port 202 toward the third small chamber 216c on the downstream side. The plural small chambers 215 are arranged such that partial annular rings are superimposed in the entire breather chamber 129.

The partially annual small chambers 215 arranged in the above-described manner generate centrifugal force in the flow of the blowby gas. This centrifugal force centrifugally separates the splashed lubricating oil contained from the blowby gas. The breather chamber 129 synergizes the centrifugal effect on the zigzag flow path of the blowby gas.

In the flow of the blowby gas, the small chamber 215 on the downstream side of the second small chamber 216b, i.e., the third small chamber 216c includes a partition plate 223. The partition plate 223 is provided on the right case half 52, and causes the blowby gas to flow from the side of the right case half 52 (the side of the partial small chamber 215a) of the third small chamber 216c to the side of the left case half 51 (i.e., the side of partial small chamber 215b) and again to the side of the right case half 52.

The partition plate 223 reaches the mating surface 41a of the third small chamber 216c and bisects the partial small chamber 215a. In other words, the partition plate 223 bends the flow of the blowby gas inside the third small chamber 216c.

The plural small chambers 215 are partitioned by the partition wall 221 having a large radius of curvature as the small chambers 215 are more separated from the blowby-gas inlet port 202 (i.e., toward the downstream side), and become a partially annular shape having a large radius of curvature. Thus, it is easier for the small chamber 215 on the downstream side to have a larger volume than the small chamber 215 on the upstream side. For this reason, by further subdividing the small chamber 215 on the downstream side of the second small chamber 216b (i.e., the third small chamber 216c) with the use of the partition plate 223, the flow of the blowby gas is bent a number of times such that the splashed lubricating oil contained is separated from the blowby gas.

Note that plural partition plates 223 may be provided in one small chamber 215. That is, the partition plate 223 is provided on the right case half 52 or the left case half 51 such that the flow of the blowby gas is led from one case half side of the small chamber 215 (i.e., either of the right and left case halves 52 and 51) to the other case half side (i.e., the other of the right and left case halves 52 and 51) and again to the one case half side.

At the bottom of each of the small chambers 215, an oil outflow hole 225 is provided for letting out the condensed lubricating oil in the small chamber 215. Each oil outflow hole 225 straddles the mating surface 41a of the crankcase 41. Each oil outflow hole 225 is an opening combining cutout-shaped recesses provided in the respective right and left crankcase halves 52 and 51.

The breather chamber 129 according to the embodiment of the present invention causes the blowby gas to flow from the clutch chamber 203 into the lower right corner 217aa of the first small chamber 216a through the blowby-gas inlet port 202, as shown by the solid arrow f1 in FIG. 14.

Further, the breather chamber 129 leads the blowby gas having flown into the lower right corner 217aa of the first small chamber 216a to the upper left corner 217bb of the first small chamber 216a through the central portion of the first small chamber 216a (near the mating surface 41a), as shown by the solid arrow f2 in FIG. 15.

The breather chamber 129 causes the blowby gas having reached the upper left corner 217bb of the first small chamber 216a to flow into the upper left corner 217bb of the second small chamber 216b through the first blowby-gas flow port 218a, as shown by the solid arrow f3 in FIG. 15.

The breather chamber 129 leads the blowby gas having flown into the upper left corner 217bb of the second small chamber 216b to the lower right corner 217aa of the second small chamber 216b through the central portion of the second small chamber 216b (i.e., near the mating surface 41a), as shown by the solid arrow f4 in FIG. 15.

The breather chamber 129 causes the blowby gas having reached the lower right corner 217aa of the second small chamber 216b to flow into the lower right corner 217aa of the third small chamber 216c through the second blowby-gas flow port 218b, as shown by the solid arrow f5 in FIG. 14.

The breather chamber 129 leads the blowby gas having flown into the lower right corner 217aa of the third small chamber 216c from the side of the right case half 52 (i.e., the side of the partial small chamber 215a) to the side of the left case half 51 (i.e., the side of the partial small chamber 215b) and again to the side of the right case half 52 such that the blowby gas bypasses the partition plate 223 as shown by the solid arrow f6 in FIG. 15.

Furthermore, the breather chamber 129 causes the blowby gas having reached the upper right corner 217ab of the third small chamber 216c to flow out from the blowby-gas outflow pipe 226 that protrudes to the outer surface of the crankcase 41, as shown by the solid arrow f7 in FIG. 14.

In the breather chamber 129, the arrangement of the flow passage of the blowby gas between the blowby gas inlet port 202 and each of the small chambers 215 may be reversed upside down and/or be reversed to the left and right with respect to the engine 11. For instance, the blowby-gas inlet port 202 may be provided in the left case half 51, and the arrangement of the blowby-gas flow ports (the first blowby-gas flow port 218a and the second blowby-gas flow port 218b) connecting the respective small chambers 215 may also be reversed in the right-and-left direction.

In addition, the blowby-gas inlet port 202 may be connected to the upper right corner 217ab of the first small chamber 216a. In this case, it is preferable that the first blowby-gas flow port 218a connects the lower left corner 217ba of the first small chamber 216a and the second small chamber 216b. The same applies to the second blowby-gas flow port 218b.

Here, one of the right case half 52 and the left case half 51 is referred to as the first case half, and the other is referred to as the second case half. That is, the breather chamber 129 includes plural small chambers 215 that are partitioned across the first case half and the second case half.

The engine 11 includes an engine suspension boss 228 that is integrally formed with both of the first wall portion 52a of the right case half 52 for defining the breather chamber 129 and the second wall portion 51a of the left case half 51 for defining the breather chamber 129. The engine suspension boss 228 includes a boss half 228a provided integrally with the right case half 52 and a boss half 228b provided integrally with the left case half 51. The boss half 228a and the boss half 228b are coupled and integrated with each other at the mating surface 41a of the crankcase 41.

The breather chamber 129 has a labyrinth structure formed by the partition wall 221 that partitions the small chambers 215. Thus, the breather chamber 129 has higher rigidity than the other components of the crankcase 41. The engine suspension boss 228 is integrated with the breather chamber 129 having such high rigidity.

In the third small chamber 216c of the breather chamber 129, the partition plate 223 crossing its space is provided. The partition plate 223 extends in the radial direction of the engine suspension boss 228. Thus, the third small chamber 216c has higher rigidity than the other components of the crankcase 41. The engine suspension boss 228 is integrated with the third small chamber 216c of the breather chamber 129 having such high rigidity.

The engine 11 according to each of the above-described embodiments includes the piston jet 171 or 171A as shown in FIG. 9 and FIG. 10. Each of the piston jets 171 and 171A injects the lubricating oil to the pin bosses 173 when the piston 49 is at one of the top dead center TDC and the bottom dead center BDC, and injects the lubricating oil to the piston inner region 176 when the piston 49 is at the other of the top dead center TDC and the bottom dead center BDC. That is, the engine 11 alternately cools and lubricates the pin bosses 173 and the piston inner region 176 by using the pair of oil injection holes 178 or 178A, depending on whether the piston 49 is at the top dead center TDC or at the bottom dead center BDC. Consequently, the engine 11 can cool and lubricate both the piston inner region 176 and the pin bosses 173 while suppressing the injection amount of the lubricating oil per unit time. Suppressing the injection amount of the lubricating oil per unit time also contributes to reduction of the capacity required for the oil pump 96.

The engine 11 according to each of the above-described embodiments includes the piston jet 171 or 171A, injection direction of which is oriented to the injection region 182 or 182A sandwiched between the inner edge 181t of each pin boss 173 of the piston 49 at the top dead center TDC and the inner edge 181b of each pin boss 173 of the piston 49 at the bottom dead center BDC. Consequently, the engine 11 reliably cools and lubricates the pin boss 173 and the piston inner region 176 alternately at the top dead center TDC or the bottom dead center BDC from one oil injection hole 178 or 178A.

Additionally, the engine 11 according to each of the above-described embodiments includes the piston jet 171 or 171A, injection direction of which faces the piston inner region 176 than the pair of skirts 174. Consequently, the engine 11 can reliably inject the lubricating oil to the pin bosses 173 of the reciprocating piston 49 and the piston inner region 176.

Further, the engine 11 according to each of the above-described embodiments includes a pair of oil injection holes 178 or 178A that inject the lubricating oil to the corresponding pin bosses 173. Consequently, the engine 11 can easily inject the necessary and sufficient lubricating oil for cooling and lubricating the piston 49.

Moreover, the engine 11 according to each of the above-described embodiments includes the crankcase 41 that is equipped with the piston jet 171 or 171A and the oil passage 59a connected to the piston jet 171 or 171A. That is, the engine 11 includes the oil injection holes 178 or 178A that are directly bored in the crankcase 41. Consequently, in the engine 11, it is possible to easily provide the oil injection holes 178 or 178A in the narrow region sandwiched between the pair of pin bosses 173. When separate jets are provided, it is difficult to provide two separate jets in the narrow region sandwiched between the pair of pin bosses 173 in some cases, depending on the size of the piston 49. However, such a problem can be avoided in the engine 11 according to each of the above-described embodiments. In addition, it is easier for the oil injection holes 178 or 178A directly bored in the crankcase 41 to enhance the accuracy of the injection direction J than the case of separately providing jets.

Furthermore, the engine 11 according to each of the above-described embodiments includes the pair of crankcase halves 51 and 52 combined with each other at the mating surface 41a orthogonal to the rotation center line of the crankshaft 47 and the oil passage 59a of the crankcase 41 to be provided in the respective crankcase halves 51 and 52 and connected to each other at the mating surface 41a.

Consequently, in the engine 11, it is easy to form the oil passage 59a connected to the piston jet 171 or 171A in the casting case halves 51 and 52.

Therefore, the engine 11 according to each of the above-described embodiments can inject the lubricating oil to the piston inner region 176 and the pin bosses 173 located in the outer region of the piston with the use of smaller number of piston jet 171 or 171A.

1. An internal combustion engine comprising:
a cylinder having a cylinder bore;
a piston configured to reciprocate in the cylinder bore; and
an oil injector configured to inject lubricating oil to the piston,
wherein the piston includes a pair of pin bosses, a pair of skirts, a pair of side walls that connect the pair of pin bosses to the pair of skirts, and a piston inner region that is surrounded by respective inner surfaces of the pair of pin bosses, respective inner surfaces of the pair of skirts, and respective inner surfaces of the pair of side walls; and
wherein the oil injector is configured to inject the lubricating oil to the pair of pin bosses when the piston is at one of a top dead center and a bottom dead center, and inject the lubricating oil to the piston inner region when the piston is at another of the top dead center and the bottom dead center.

2. The internal combustion engine according to claim 1, wherein the oil injector is configured to inject the lubricating oil to the pair of pin bosses when the piston is at the top dead center, and inject the lubricating oil to the piston inner region when the piston is at the bottom dead center; and
wherein an injection direction of the oil injector is oriented toward a region sandwiched between an inner edge of each of the pin bosses of the piston at the top dead center and an inner edge of each of the pin bosses of the piston at the bottom dead center.

3. The internal combustion engine according to claim 1, wherein an injection direction of the oil injector faces the piston inner region than the pair of skirts.

4. The internal combustion engine according to claim 1, wherein the oil injector includes a pair of oil injection holes configured to inject the lubricating oil to the corresponding pin bosses.

5. The internal combustion engine according to claim 1, further comprising a crankcase that includes the oil injector and an oil passage connected to the oil injector.

6. The internal combustion engine according to claim 5, further comprising a crankshaft rotatably supported inside the crankcase,
wherein the crankcase includes a pair of case halves combined with each other at a mating surface that is orthogonal to a rotational center line of the crankshaft; and
wherein the oil passage is provided with a plurality of partial passages that are provided in the respective case halves and are connected at the mating surface.

7. The internal combustion engine according to claim 3, wherein the oil injector includes a pair of oil injection holes configured to inject the lubricating oil to the corresponding pin bosses.

8. The internal combustion engine according to claim 3, further comprising a crankcase that includes the oil injector and an oil passage connected to the oil injector.

9. The internal combustion engine according to claim 8, further comprising a crankshaft rotatably supported inside the crankcase,
wherein the crankcase includes a pair of case halves combined with each other at a mating surface that is orthogonal to a rotational center line of the crankshaft; and
wherein the oil passage is provided with a plurality of partial passages that are provided in the respective case halves and are connected at the mating surface.
